(19) United States
(12) Patent Application Publication
(10) Pub. No.: US 2026/0145812 A1
(43) Pub. Date: May 28, 2026

(54) METHOD, PROCESS AND SYSTEM FOR AUTOMATING AND CONFIGURING AIRCRAFT DE-ICING/ANTI-ICING

(71) Applicant: JCAI INC., Cambridge (CA)

(72) Inventor: Jeffery Paul CAMPBELL, Cambridge (CA)

(21) Appl. No.: 19/262,456

(22) Filed: Jul. 8, 2025

Related U.S. Application Data
(63) Continuation of application No. 18/007,566, now abandoned.
(60) Provisional application No. 63/034,680, filed on Jun. 4, 2020.
(60) Provisional application No. 63/042,720, filed on Jun. 23, 2020.
(60) Provisional application No. 63/172,396, filed on Apr. 8, 2021.

(51) Int. Cl. B64F 5/20; B64F 1/00; B64F 5/40

(52) U.S. Cl. CPC B64F 5/20; B64F 1/002; B64F 5/40

(57) ABSTRACT

A method and system for automating the de-icing/anti-icing of an aircraft that includes the generation of a treatment plan that incudes input from at least one weather source. The treatment plan may then be reviewed by a pilot to any updates. After being finalized, the treatment plan is distributed to at least one de-icing vehicle to perform the de-icing/anti-icing of the aircraft. During execution of the de-icing/anti-icing, real-time updates may be provided by the system to the pilot of the aircraft.

### CROSS-REFERENCE TO OTHER APPLICATIONS

This application is a continuation claiming priority from U.S. application Ser. No. 18/007,566 dated Dec. 1, 2022 which further claims priority from U.S. Provisional Application Nos. 63/034,680; 63/042,720; and 63/172,396 filed Jun. 4, 2020; Jun. 23, 2020; and Apr. 8, 2021, respectively, which are also hereby incorporated by reference.

### FIELD

The disclosure is generally directed at the aviation industry and, more specifically, is directed at a method and system for automating and configuring aircraft de-icing.

### BACKGROUND

In the aviation industry, the ability to keep aircraft on schedule is an important task. While this may be easier during nicer weather, in the winter, the weather typically affects scheduled departure times. One of the reasons for this is that aircraft need to undergo a De-icing/Anti-icing process in order to remove ice build-up on the wings and fuselage of the aircraft. However, the number of de-icing bays within a de-icing facility or facilities, such as within an airport, is typically much lower than the number of aircraft that are preparing for take-off at any one time. As such, there is a need to manage these aircraft in order to facilitate the de-icing/anti-icing process for aircraft within an airport.

Therefore, there is provided a method and system for automating and configuring aircraft de-icing/anti-icing.

### SUMMARY

The disclosure is directed at a method and system for automating and configuring aircraft de-icing/anti-icing. In one embodiment, the system uses environment representative graphics from a top view perspective for facilitating and co-ordinating (automated and remote) de-icing services for aircraft. In another embodiment, the system includes multiple distributed processing units that direct aircraft (or pilots) through the de-icing/anti-icing process at an airport.

In one aspect of the disclosure, there is provided a method of automating aircraft de-icing/anti-icing including generating a treatment plan for aircraft de-icing/anti-icing; communicating the treatment plan to a pilot module associated with the aircraft for input relating to the treatment plan from a pilot associated with the aircraft; updating the treatment plan based on the input from the pilot; and transmitting the updated treatment plan to at least one de-icing/anti-icing vehicle for performance of the updated treatment plan; wherein generating the treatment plan for aircraft de-icing/anti-icing includes receiving or retrieving weather information.

In another aspect, the method further includes receiving a request for aircraft de-icing/anti-icing before generating the treatment plan for aircraft de-icing/anti-icing. In yet a further aspect, the method includes receiving a request for aircraft de-icing/anti-icing after generating the treatment plan for aircraft de-icing/anti-icing. In yet another aspect, generating the treatment plan includes receiving weather information from METAR or Nowcasting. In another aspect, updating the treatment plan includes determining a physical location for performing the aircraft de-icing/anti-icing where the physical location is a gate location, an apron location or a designated de-icing facility (DDF). In a further aspect, if the physical location is a gate location, transmitting the updated treatment plan to at least one de-icing/anti-icing vehicle for performance of the updated treatment plan includes transmitting the gate location to the at least one de-icing/anti-icing vehicle. In yet a further aspect, if the physical location is a DDF, the method further includes guiding the aircraft from its current location to the DDF. In an aspect, guiding the aircraft from its current location to the DDF includes controlling taxiway inset guidance lights. In another aspect, guiding the aircraft from its current location to the DDF includes transmitting messages to the pilot via electronic message boards (EMBs). In a further aspect, after the aircraft de-icing process has commenced, receiving de-icing/anti-icing process updates from the at least one de-icing/anti-icing vehicle; and transmitting the de-icing/anti-icing process updates to the pilot application.

In another aspect, receiving de-icing process updates includes receiving real-time video from the at least one de-icing/anti-icing vehicle. In a further aspect, transmitting the de-icing/anti-icing process updates includes transmitting the real-time video to the pilot application. In another aspect, the method further includes transmitting the de-icing/anti-icing process updates to electronic message boards. In yet another aspect, the method includes determining when an aircraft has set its brakes; and transmitting a message to the at least de-icing/anti-icing vehicle that it is safe to proceed. In yet a further aspect, the method further includes receiving confirmation from the at least one de-icing/anti-icing vehicle that the de-icing/anti-icing treatment is complete and that the at least one de-icing/anti-icing vehicle is in a safe zone; and transmitting a signal to the pilot via the pilot module that the aircraft may proceed to take-off. In another aspect, the method further includes transmitting control of the system to the de-icing module after transmitting the message to the at least de-icing/anti-icing vehicle that it is safe to proceed. In another aspect, the method further includes receiving control of the system after receiving confirmation from the at least one de-icing/anti-icing vehicle that the de-icing/anti-icing treatment is complete and that the at least one de-icing/anti-icing vehicle is in a safe zone.

In another aspect of the disclosure, there is provided a non-transitory computer readable medium having stored thereon software instructions that, when executed by a processor, cause the processor to: generate a treatment plan for aircraft de-icing/anti-icing; communicate the treatment plan to a pilot module associated with the aircraft for input relating to the treatment plan from a pilot associated with the aircraft; update the treatment plan based on the input from the pilot; and transmit the updated treatment plan to at least one de-icing/anti-icing vehicle for performance of the updated treatment plan; wherein generating the treatment plan for aircraft de-icing/anti-icing includes receiving or retrieving weather information.

### BRIEF DESCRIPTION OF THE DRAWINGS

Embodiments of the present disclosure will now be described, by way of example only, with reference to the attached Figures.

FIG. 1 is a schematic diagram of an embodiment of the system;

FIG. 2a is a flowchart outlining a method of controlling a de-icing/anti-icing process;

FIG. 2b is a flowchart method of a method of generating a treatment plant template;

FIGS. 3a to 3l are example screens shots associated with the method of FIG. 2a;

FIG. 4 is a schematic diagram of a treatment plan engine;

FIG. 5 is a flowchart outlining another embodiment of a method of establishing a treatment plan and controlling a de-icing/anti-icing process;

FIGS. 6a to 6f are example screenshots;

FIGS. 7a to 7g are further screenshots;

FIGS. 8a to 8n are further screenshots;

FIGS. 9a to 9k are exemplary photographs and screenshots;

FIG. 10 is a schematic diagram of a screenshot showing safety zones;

FIG. 11 is a photograph of a camera tower;

FIG. 12 is a panoramic photograph;

FIG. 13 is a schematic diagram of another embodiment of a system for controlling a de-icing/anti-icing process;

FIG. 14 is a photograph of a camera tower and message board;

FIG. 15 is a schematic diagram of data flow for a detection system;

FIG. 16 are a series of photographs of de-icing bays;

FIG. 17 is a screenshot of a detection system display;

FIG. 18 is a screenshot of a digitized aircraft model;

FIG. 19 is a screenshot;

FIGS. 20 and 21 are photographs of de-icing/anti-icing being performed;

FIG. 22 is a photograph of an obstructed view for a detection system; and

FIG. 23 is a schematic diagram of a de-icing vehicle camera system.

### DETAILED DESCRIPTION

In order to facilitate a de-icing/anti-icing process for an aircraft, the disclosure provides a system and method for managing the de-icing/anti-icing process from a central point of control, thereby reducing, and possibly eliminating, the need for people and/or motorized equipment to marshal aircraft. In the following disclosure, use of the term de-icing may also include anti-icing.

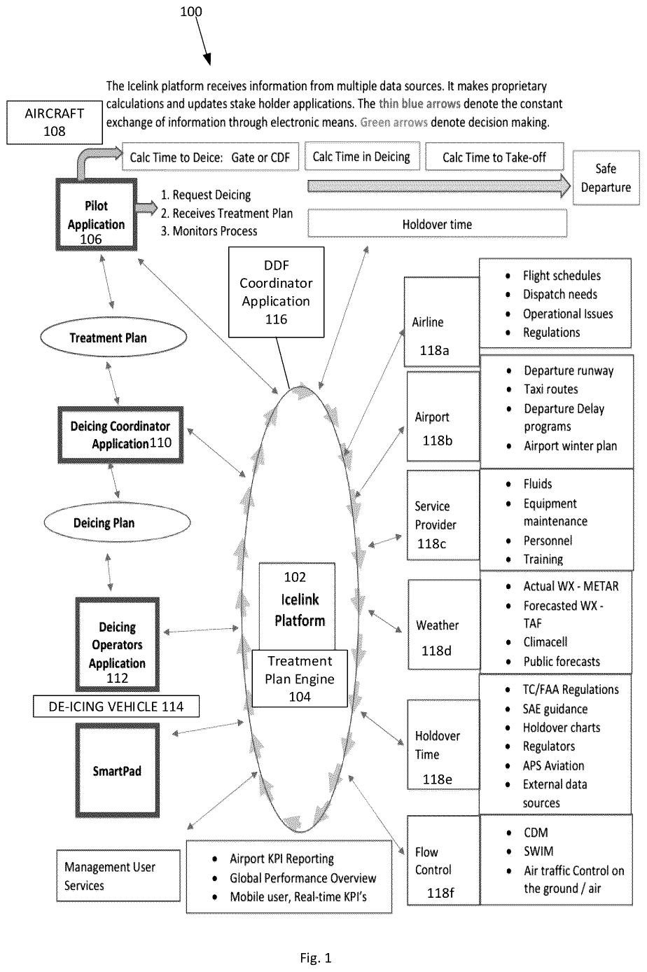

Turning to FIG. 1, a schematic diagram of a system for automated control of a de-icing/anti-icing process for an aircraft is shown.

The system 100 includes a central processing unit (CPU) 102 that may be seen as a de-icing functionality platform, ICELINK™ platform or a central hub for the system to control and coordinate a de-icing/anti-icing process for an aircraft. The platform 102 may also be seen as an application, or module, for co-ordinating communication between different modules, or applications, of the system 100 and other external applications, modules or devices. It may also be seen as system for coordinating and scheduling action or treatment plans among the main stakeholders that engage the system such as, but not limited to, a pilot, de-icing operators and a de-icing coordinator. Within the CPU 102 may be a treatment plan engine 104 that may assist to develop or generate a treatment plan template and/or a treatment plan.

In one embodiment, they system 100 may include a pilot application, or module, 106 that is associated with an aircraft 108 that is requesting de-icing/anti-icing. The pilot may communicate with the platform 102 via the pilot application 106.

Although only one is shown, it is understood that there may be multiple aircraft (or pilots) that are communicating with the system whereby each aircraft may be equipped with a pilot application 106. In one embodiment, the pilot application 106 may be stored on a pilot device, which may be seen as a mobile communication device, such as a Smartphone, a Tablet and the like, located within the aircraft or may be stored on the aircraft's on-board processor.

The pilot module 106 may be used for, but not limited to, requesting de-icing/anti-icing, receiving a treatment plan relating to the request for de-icing/anti-icing and for monitoring or displaying updates of the de-icing/anti-icing process as it is being performed such as by receiving updates from the CPU 102 with respect to the de-icing/anti-icing being performed on the aircraft. The generation of a request for de-icing/anti-icing may require input from a user, such as the pilot, who may select areas of the aircraft that require the de-icing/anti-icing treatment. The request for de-icing/anti-icing may also include other information associated with the aircraft, such as, aircraft type, name of aircraft company and/or scheduled departure time. In other embodiments, the pilot may be provided with a default treatment plan template by the system 102 where the pilot may update the treatment plan template by selecting areas of the aircraft the pilot wishes to receive de-icing/anti-icing treatment or to respond to other questions or to fill in requested information. The pilot module allows pilots to plan and specify de-icing/anti-icing activities for their aircraft from the aircraft cockpit while they are at the gate or other location.

In other embodiments, based on inputs from the system, the pilot module may display schedule information such as, but not limited to, time in queue, time to take off, time to arrival of de-icing vehicles and Holdover Time (HOT).

In some embodiments, the pilot application may be implemented via software, firmware or hardware, that is installed as part of the pilots EFB (Electronic Flight Bag). When implemented on a processor, the module allows the pilot to request and plan de-icing/anti-icing. In one embodiment, the pilot logs into the system (via the pilot application and then communicates with the CPU to request de-icing and/or anti-icing services.

The system 100 may further include a de-icing coordinator application, or module, 110, that is associated with a de-icing coordinator. Although shown separate from the platform 102, the co-ordinator module 108 may also be integrated within the platform 102. The de-icing coordinator may use the application, which may be stored on a mobile communication device, to oversee treatment plans and to assist in the co-ordination of the de-icing/anti-icing for the requesting aircraft, where necessary. This oversight may also be implemented within, or performed by, the de-icing coordination application 110.

In one embodiment, the de-icing co-ordinator module 110 may be used to generate, or update, the treatment plan when requested by the pilot module 106. The treatment plan may include information such as, but not limited to, the physical location within the airport where the treatment is going to take place, the type of contamination treatment (either 1 Step (de-icing) or 2 Step (de-icing and anti-icing)) and/or the locations on the aircraft where treatment is required. Other information may be provided on the interface (or co-ordinateor module) such as the Metar/TAF, Weather Radar and Nowcasting.

In another embodiment, the treatment planning done by the coordinator module uses all available weather information or input including, but not limited to, METAR, TAF and Nowcasting that is available for the coordinator/co-ordinator module on the dispatch user interface. The coordinator or the coordinator module accesses the weather and may then determine a treatment plan such as a 1 step de-icing process (Type 1 fluid only) or a 2 step process, such as in snow or other freezing precipitation, using type 1 de-icing fluid first then anti-icing Type IV fluid second.

In one embodiment of the de-icing coordinator application 110, the application 110 provides the functionality of planning and scheduling of aircraft to be de-iced, traffic control of aircraft and transmission of notifications to a pilot or pilots. The notifications may be transmitted via electronic message boards (EMBs) or through the control of lighting through the airport at the DDF Facility. The de-icing coordinator application 110 works in conjunction with the pilot application 106 and the de-icing operator application or applications 112 depending on how many de-icing vehicles are required to execute the treatment plan for the de-icing/anti-icing. More specifically, the de-icing coordinator module 110 may prepare aircraft specific de-icing/anti-icing treatment plans; schedule aircraft into the DDF and for gate de-icing, and/or schedule de-icing vehicles and manpower against the aircraft de-icing schedule.

The system 100 further includes a set of de-icing operator applications, or modules, 112, that are associated with individual de-icing vehicles 114 and/or the individuals operating the de-icing vehicles. Each de-icing operator module 112 may be used to generate specific actions (based on instructions or signals from the platform 102) that need to be taken by the de-icing operator or the de-icing machinery in order to implement or execute the treatment plan generated by the system 100. In one embodiment, the de-icing treatment plan may require more than one de-icing operators or vehicles to execute such that the system may include multiple de-icing operator modules and vehicles.

Together these modules allow the users of the system 100 to generate and execute a treatment plan for aircraft de-icing/anti-icing such as specifying the details of de-icing an aircraft, providing aircraft traffic control and tracking, reporting and/or displaying the de-icing process for each aircraft.

The system may further include a centralized de-icing facility (DDF) coordinator application, or module, 116 that is associated with a DDF location.

The system 100 may also be connected to various external information sources 118 to receive information or data to assist in the generation of the treatment plan and the like. The external information sources 118 may include, but are not limited to, an airline database or server 118a, an airport database or server 118b, a service provider database or server 118c, a weather database or server 118d, a holdover time database or server 118e and/or a flow control database or server 118f.

The airline database 118a may provide information, such as, but not limited to, flight schedules, dispatch needs, operational issues and/or regulations. The airport database 118b may provide information, such as, but not limited to, departure runway information, taxi routes, departure delay programs and/or an airport winter plan. The use of new technology can be incorporated into the IceLink platform such as airport SWIM data, or other visual taxi aids within an EFB (Electronic Flight Bag). The flow control database 118f may provide CDM information, SWIM information and/or air traffic control on the ground/air. The service provider database 118c may provide information such as, but not limited to, a level of or types of fluid available for De/Anticing, equipment maintenance information, personal information and/or training information. The weather database 118d may provide information such as, but not limited to, actual weather information (from METAR), forecasted weather information (TAF), Nowcasting information and/or public forecasts. The holdover time database 118e may provide information such as, but not limited to, TC/FAA regulations, SAE guidance, holdover charts information, regulators information, APS aviation information, and/or external data sources. In one embodiment, the HOT provided to the pilot module will include a temperature specific HOT time when available.

The CPU 102 may also perform, or provide airport KPI reporting, global performance overview and/or module user real time KPIs. Furthermore, the system 100 may also include the functionality of providing management user services.

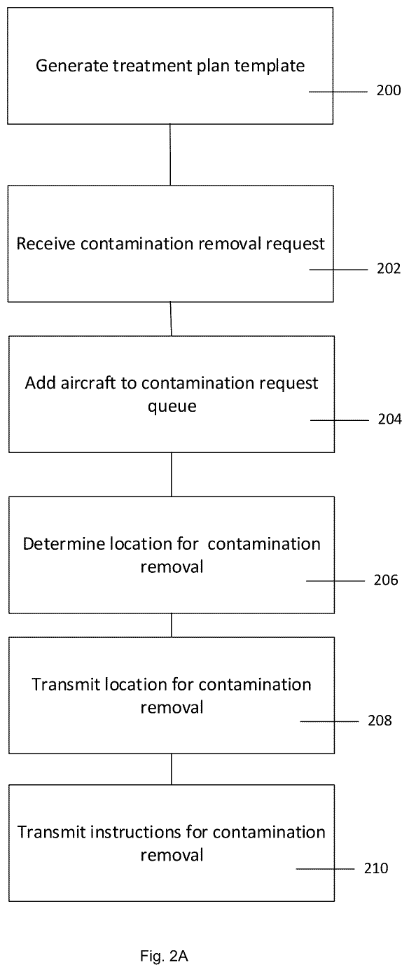

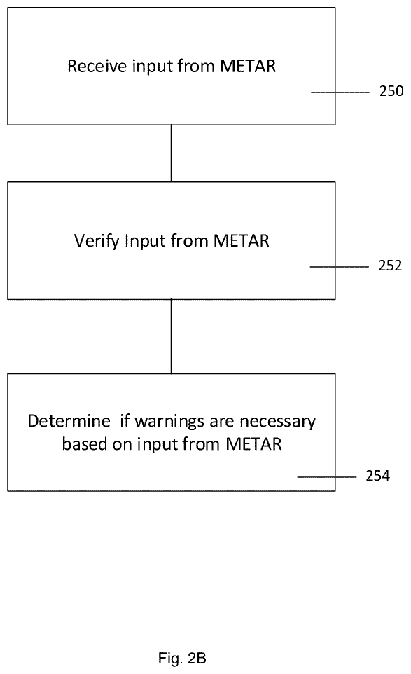

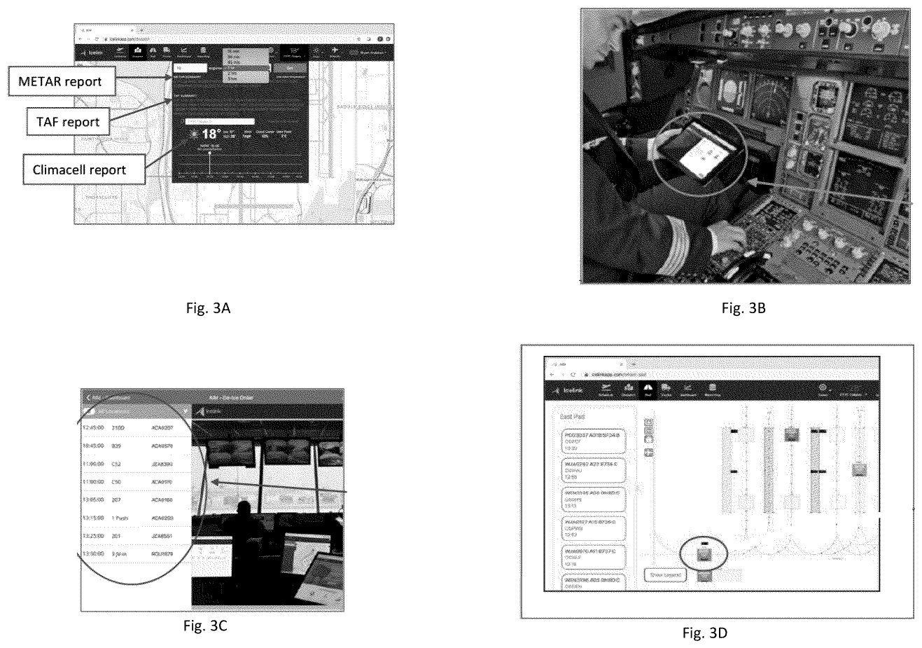

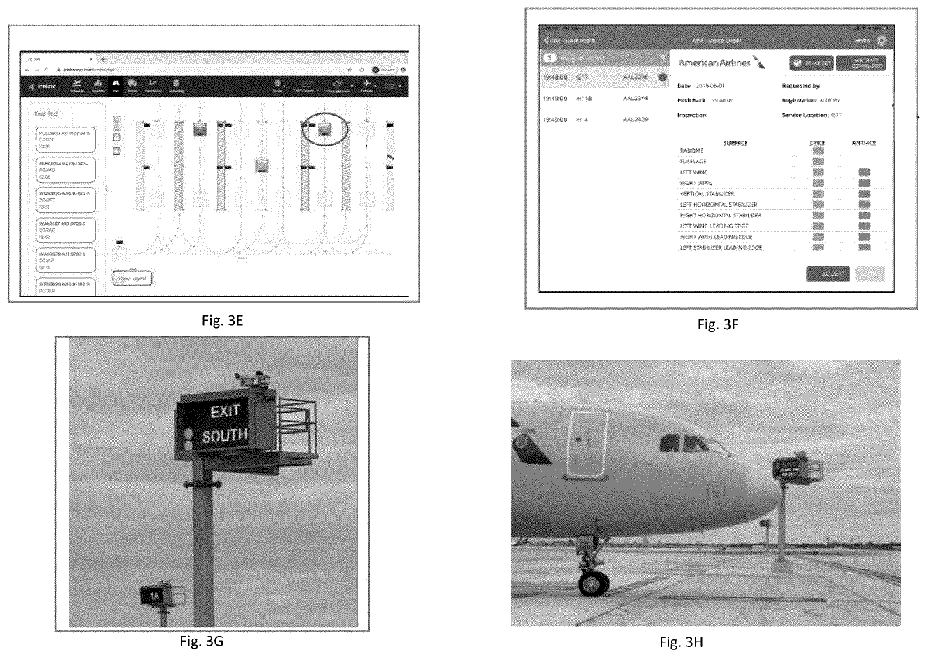

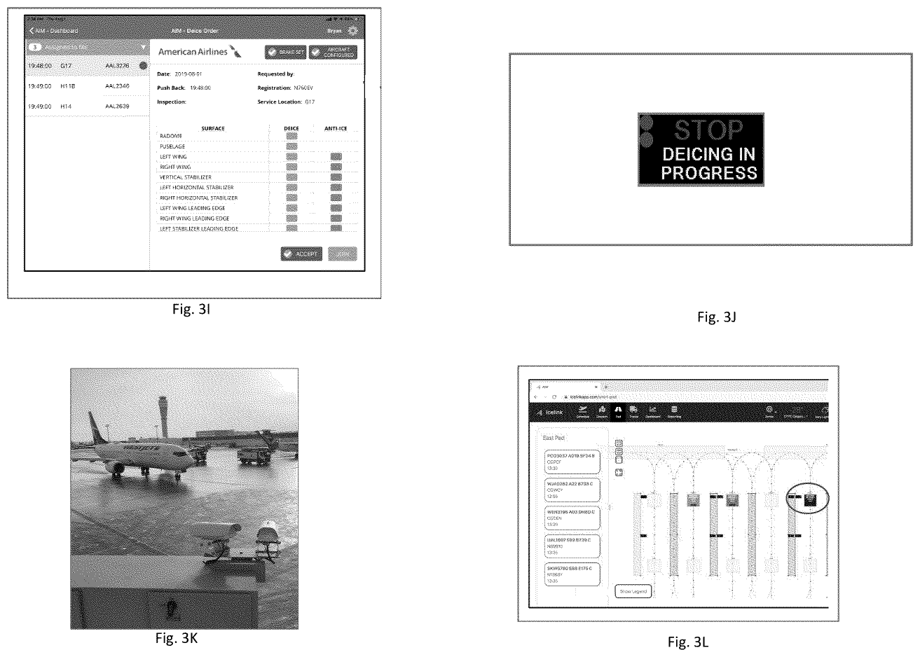

Turning to FIG. 2a, a flowchart outlining a method of providing de-icing/anti-icing for an aircraft is shown. FIGS. 3a to 3l provide example screen shots of may be shown by the modules to users.

Initially, the system generates a default treatment plan, or treatment plan template (200). This may be generated by the co-ordinator module 110, or the CPU 102 or a combination of both.

One embodiment of generating a treatment plan template is schematically shown in FIG. 2b. The template may be based on inputs from external sources such as, but not limited to, input from METAR. For instance, METAR may provide weather forecast information (that is received (250) by the system) that may enable some information associated with the treatment plan to be pre-filled based on the current weather or a weather forecast.

The co-ordinator module may or the co-ordinator (a user) may, via the co-ordinator module, verify the weather information provided by METAR (252) by referencing the terminal aerodrome forecast (TAF) and, if regionally provided, a Nowcasting weather report. A schematic screen shot is shown in FIG. 3a. As such, the default treatment plan may be continuously updated based on the input received from METAR where some information on the template may be pre-populated by the system. Also, the system may be able to issue warnings or alerts (254) based on the weather information. For instance, if one of the de-icing vehicles attempts to spray an aircraft outside of the 10oC OAT, an alert may be generated.

Turning back to FIG. 2a, concurrently, following a pre-flight inspection, the pilot may determine that de-icing/anti-icing is required, and if so, makes a request for de-icing/anti-icing, via the pilot application module (which may also be seen as a contamination removal request). This is schematically shown in FIG. 3b. The pilot may then communicate the request, such as via the pilot application or module stored on the pilot, or aircraft, device, to the CPU 102 (that is received by the CPU) (202).

In one embodiment, the request from the pilot may cause the system (or CPU 102) to transmit the treatment plan template to the pilot application 106 for the pilot to enter the missing information. In another embodiment, the request from the pilot may include all the information that is required for a treatment plan to be generated.

The contamination removal request may include information such as, but not limited to, areas of the aircraft that require de-icing/anti-icing, identification of the aircraft, size of the aircraft, scheduled departure time, scheduled departure gate and/or current gate location. Determination of the areas of the aircraft that require de-icing/anti-icing may be assisted with a set of cameras that are located on the de-icing truck, the aircraft body or may be mounted in predetermined locations around the gate location or DDF.

After the request is received, such as via the co-ordinator module, information associated with the request is input into a de-icing/anti-icing queue listing (204). This is schematically shown in FIG. 3c. In one embodiment, the co-ordinator module, on the co-ordinator device, may receive the request and the flight information is automatically added to the de-icing/anti-icing queue listing.

The system then determines a physical location (206) (for instance de-icing/anti-icing stations (such as a DDF) within the airport) that is available to receive the aircraft for performing the de-icing/anti-icing. In another embodiment, the system may determine that the aircraft should stay at its current location and de-icing equipment (such as one or more de-icing trucks or vehicles) will travel to the aircraft's location to deliver the de-icing/anti-icing treatment. This location may be on the airport apron, tarmac or at a gate location. The system may then display to the coordinator a set of options to select the physical location and to transmit the selected physical location (208) to the aircraft and/or the one or more de-icing vehicles depending on the selected physical location.

In one embodiment, where the aircraft travels to a de-icing/anti-icing location, such as, but not limited to, a DDF threshold, the system may transmit a request to a DDF coordinator (such as via the DDF coordinator module) for de-icing bay assignment instructions. The de-icing coordinator, via the de-icing coordinator module, can then select the flight from the queue listing and assign it to a free de-icing bay based on the input from the DDF coordinator module. The physical location is then transmitted to the aircraft such that it may be seen as the system instructing the aircraft to proceed to the designated de-icing staging or de-icing bay. In some embodiments, the system may control surface lights to make them illuminate automatically to assist the aircraft in parking in the de-icing bay. In one example, the coordinator, via the coordinator module, may light up a flight strip marker in the designated bay by simply clicking on an icon on the screen. This is schematically shown in FIGS. 3d and 3e.

In embodiments where the at least one de-icing vehicles is travelling to the aircraft location, the coordinator module transmits instructions or signals to at least one selected de-icing vehicle instructing the at least one de-icing vehicle to travel to the physical location where the de-icing/anti-icing treatment is to take place. In some embodiments, the instructions may be transmitted to the de-icing operator's module which is reviewed by a de-icing operator who then drives the de-icing vehicle to the physical location. In another embodiment, the co-ordinator module transmits the instructions directly to an on-board processor of the de-icing vehicle which may then autonomously travel to the physical location.

In one embodiment, although not necessary for each embodiment, the system may transmit signals to the automated signage boards that are located throughout the airport to transmit messages to the pilot or to airport personnel or the de-icing vehicle operators as they are travelling to the de-icing/anti-icing location. This is schematically shown in FIG. 3g. The system may also set surface lights to indicate the path and actions the aircraft, or de-icing vehicles, has been instructed to follow.

As shown in FIG. 3g, the system may include indicators to determine when it is safe for the treatment to commence. For example, the system may include sensors to determine when the brakes on the aircraft are set and to provide surface lights showing the pilot where to stop when arriving at the physical location. FIG. 3h provides a screen shot that may be displayed on the de-icing application module indicating it is safe for the de-icing vehicle to approach the aircraft to commence the de-icing/anti-icing treatment.

Once it is confirmed that the aircraft and the at least one de-icing vehicles are in place, the co-ordinator module may transmit the de-icing/anti-icing instructions, or de-icing/anti-icing treatment plan to the at least one de-icing vehicles (210). Control of the system may also be transferred by the system to the de-icing operators module.

In one embodiment, de-icing/anti-icing treatment does not start until each of the de-icing operators applications (associated with the assigned de-icing vehicles) receive confirmation that the brakes of the associated aircraft are set (indicating that it is safe for the de-icing vehicle to approach the aircraft) along with the configuration of the aircraft. This is schematically shown in FIG. 3f.

As the de-icing/anti-icing process is being performed, the status of the treatment may be displayed to the pilot (via the pilot module), based on input from the de-icing operator of the de-icing vehicle into the de-icing operator application of base don input form the de-icing vehicle itself. For example, de-icing vehicle may include cameras, or the system may include cameras, that are directed at the aircraft while the treatment is taking place so that the pilot may, in real time, observe the treatment being performed. Further details with respect to the cameras and their operation is disclosed below.

In one embodiment, the de-icing vehicle may be integrated with or have a camera or detection system installed. In one embodiment, the camera system performs ice detection without human subjectivity and at greater accuracy, resolution and repeatability. Objective assessment is accomplished by way of controlled illumination and electro-optical (EO) data acquisition. The data acquired is spatial (imaging), and spectral in nature. Furthermore, interpretation of the data is accomplished by way of artificial intelligence (AI), meaning that a trained neural network is employed, as opposed to human interpretation of the acquired data.

Advantages of the current camera system include improved sensitivity as the EO sensors and relevant conditions yield more consistent measurements and provide higher sensitivity to the optical signals being detected than human vision. Another advantage that is provided is an improved resolution when detecting the ice on the aircraft since the optical system design for specific EO sensors and provides an ability to achieve higher spatial resolution than that achievable by human vision. Also, the use of AI algorithms enables versatility concurrent with repeatability and objectivity in data assessment.

In one embodiment, the camera system installed on the de-icing vehicle includes both visible (VIS) and short-wave infrared (SWIR) imaging cameras to enable acquisition of information otherwise triggered by camera frames. The set of acquired data extends beyond the capacity of human perception in both sensitivity and wavelength range.

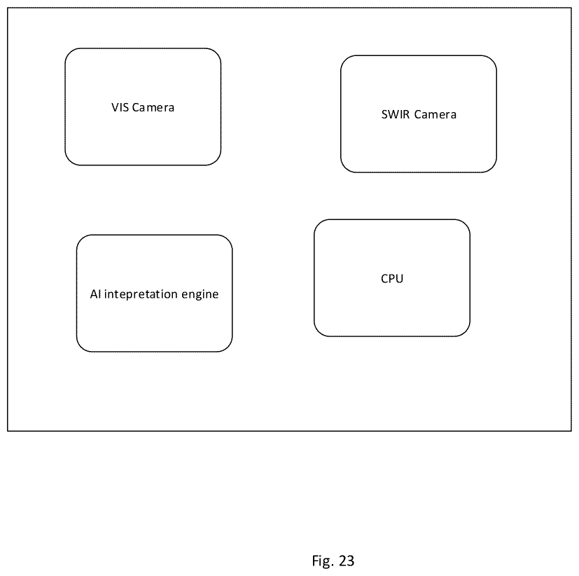

In another embodiment of the camera system (as schematically shown in FIG. 23), the camera system includes a VIS Camera; a SWIR Camera, an AI interpretation engine; and a central computer for processing, storage, display, etc.

In one configuration, the VIS and SWIR cameras may be seen as a sensor unit. The cameras are optically co-aligned to achieve a common field of view (FOV) at the desired target. The sensor unit is mounted on the de-icing vehicle, or at another position such that there is a clear view of the aircraft surface to be assessed. The sensor unit's VIS and SWIR cameras are precalibrated such that their fields of view overlap and every SWIR camera's pixel's relationship is known relative to the pixels of the VIS camera. During an assessment run, both VIS and SWIR cameras acquire image data. When necessary (e.g. night time) the cameras' acquisition systems can be enhanced using an external illumination source. The AI interpretation engine utilizes spatial information from both cameras, when assessing surface condition.

For the AI interpretation, use of application of AI to enable highly objective, repeatable and accurate interpretations of the electro-optic data under significantly varied conditions. In order to accomplish this, a database of acquired empirical data is assembled and principal component analyses of the data performed. This approach provided a system to evaluate the data with mathematical rigor to assess the pixel values to identify trends/patterns in the way the pixel values are distributed in both SWIR and visual camera images for the different contaminant types and depths.

Using the results of these mathematical tests on empirical data, a convolutional neural network was then developed and trained in order to verify that its inference capabilities would perform as required. Using a convolutional neural network as the central interpretive engine provides a versatile, extensible, and objective method for interpreting the data. Through use of mathematical rigor, exclusion of unreliable or statistically insignificant or nonrepeatable data vectors can be systematically ignored.

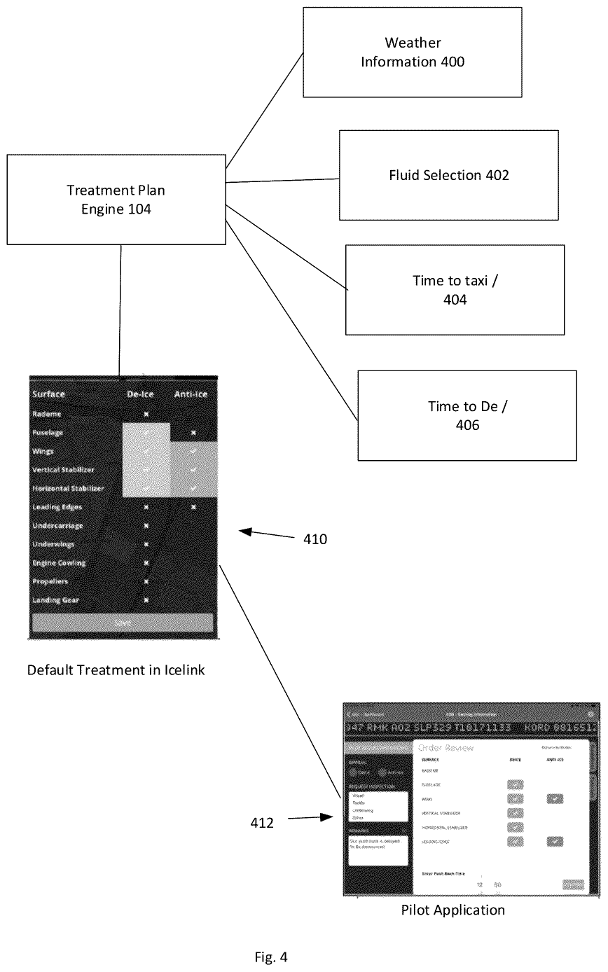

Turning to FIG. 4, a schematic diagram of one embodiment of the treatment plan engine and how it operates is shown.

In the current embodiment, the treatment plan engine 104 receives inputs from different sources, such as a weather information input 400, a fluid selection input 402, a time to taxi/take off input 404 and/or a time to de-ice/anti-ice input 406.

The weather information input 402 may include at least one of the actual reported weather (METAR), the Terminal Area Forecast (TAF) and the Nowcasting Weather Illustrator (NWI). Along with the weather information input, further weather inputs to the treatment plan engine may include weather prediction provided by Nowcasting. The fluid selection input 402 may be seen as ADF fluid performance information and the time to tax/take off input 404 may be seen as SWIM information (time to takeoff). The time to de-ice/anti-ice input 406 may be based on previously stored historical data with respect to previous de-icing/anti-icing treatments that are stored within the system or a database that is accessible by the system.

Based on the received inputs, the treatment plan engine determines or generates an aircraft specific treatment plan (schematically shown in screenshot 410).

In one embodiment, the treatment plan engine 104 analyzes the weather input 400 with respect to the other inputs 402, 404, and 406 to determine any upcoming weather pattern that may affect the decisions with respect to de-icing of the aircraft. For instance, if the aircraft has a take-off time within the next 30 minutes but there is a forecast of more snow in the next 20 minutes, the treatment plan engine 104 may determine that a specific de-icing fluid is required, such as Type 4 anti-icing fluid instead of Type 1 de-icing fluid. In another embodiment, the treatment plan engine 104 may receive the current weather forecast and determine that since there is light snow or precipitation, a Type 1 de-icing fluid is required. In another embodiment, the treatment plan engine may take into account the time to taxi and take off in determining the treatment plan (or treatment plan template) such that the aircraft will not have any ice on its surface during the taxiing and take-off time. In another embodiment, the treatment plan engine takes into consideration historical information relating similar historical weather patterns to current conditions and/or past treatments specific to this aircraft or similarly sized aircraft. After the treatment plan engine has processed the inputs, it determines the treatment plan, or treatment plan template. The output of the treatment plan, or treatment plan template, may include the fluid types versus the aircraft surfaces to be treated, and time predictions of the HOT, the time the aircraft will spend in the queue prior to de-icing (queuing time), the expected time to deice, such as processing time in the DDF and the time to take-off.

After being created, the treatment plan engine transmits the plan, or template, for review by a de-icing coordinator by displaying it on the de-icing coordinator module. In one embodiment, the de-icing coordinator may be a user who is able to review the treatment plan and make any changes, as necessary. In another embodiment, the de-icing coordinator is an automated system for reviewing the treatment plan, or template. If there are changes needed, the updated plan, or the accepted original treatment plan if no changes are required, is then received by the treatment plan engine from the de-icing coordinator and the treatment plan updated (if necessary). The updated treatment plan is then transmitted to the pilot for review (such as shown in screenshot 412) after the pilot has made a request for de-icing/anti-icing, which shows an example screenshot of a treatment plan that is presented on the pilot application to the pilot. The pilot may either accept the treatment plan or provide further amendments to the plan. The accepted, or amended, treatment plan is then received by the treatment plan engine (and necessary updates made) and distributed to at least one de-icing operator or vehicle to execute the treatment plan.

One advantage of the disclosure is that the pilot, the de-icing coordinator and the at least one de-icing operators communicate in real-time via the system to generate the treatment plan and then execute the treatment plan. The system also enables real-time updates with respect to the treatment process so that the pilot may understand how much longer is left before the treatment is complete. In one embodiment, the system may display on the pilot device a visual indication of the surfaces being treated by the at least one de-icing vehicle or real-time video with respect to the treatment process. At the completion of de-icing, a post de-icing/.anti-icing report may be provided with Holdover information if the various required elements are available. In another embodiment, the report may summarize the elapsed times and application volumes, type of fluids and the HOT. The pilot also has the ability of viewing the de-icing history of the aircraft. This may also enable the pilot to review a pre-spray treatment (on the pilot application) that was completed prior to his arrival to the aircraft.

In another embodiment, decisions on or aspects of the treatment plan can be modified as factors such as weather, airtraffic, aircraft mechinical status and available de-icing resources change.

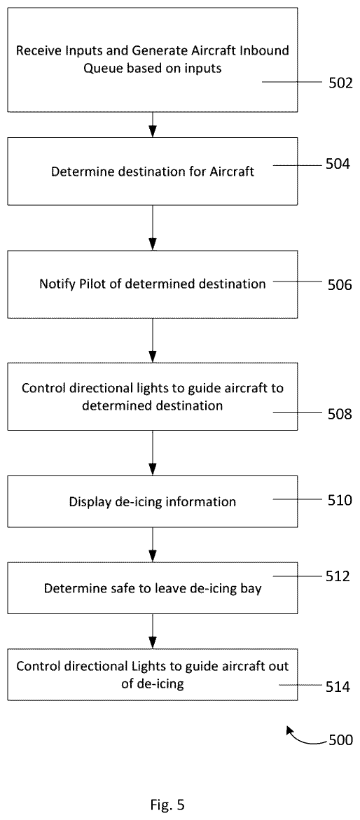

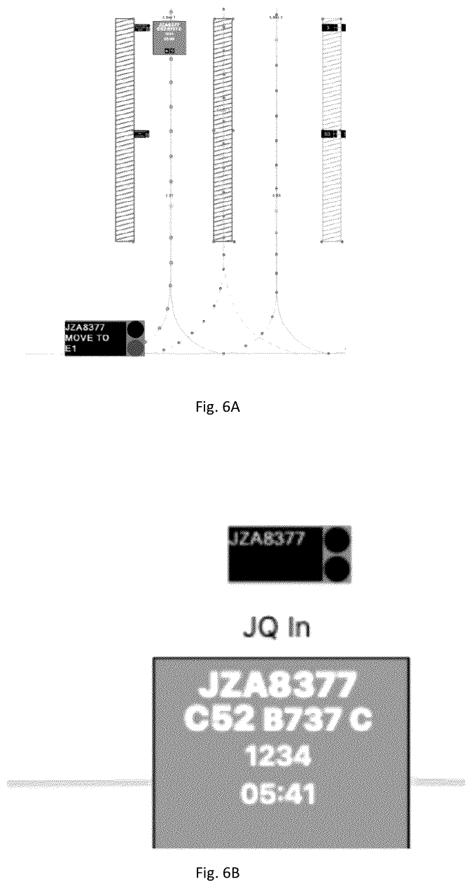

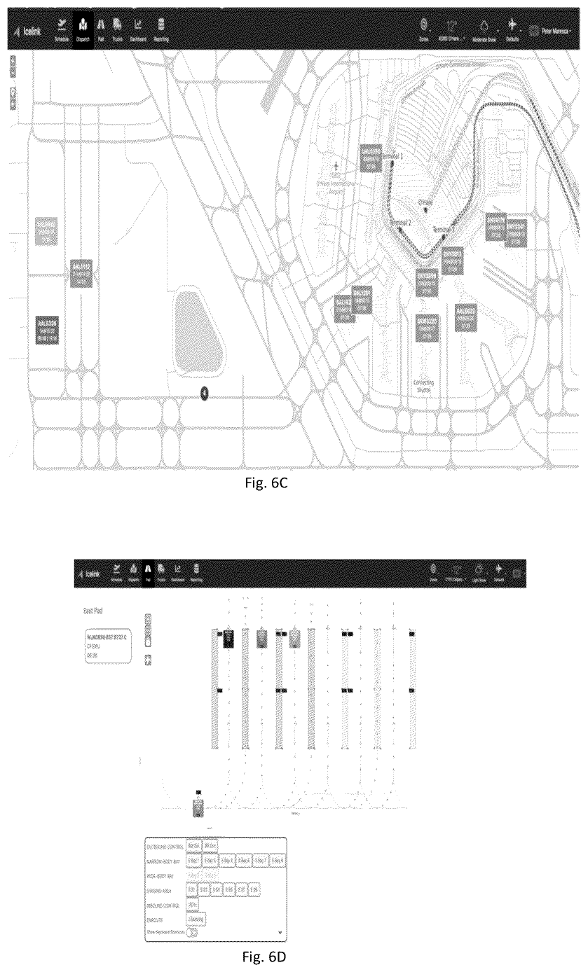

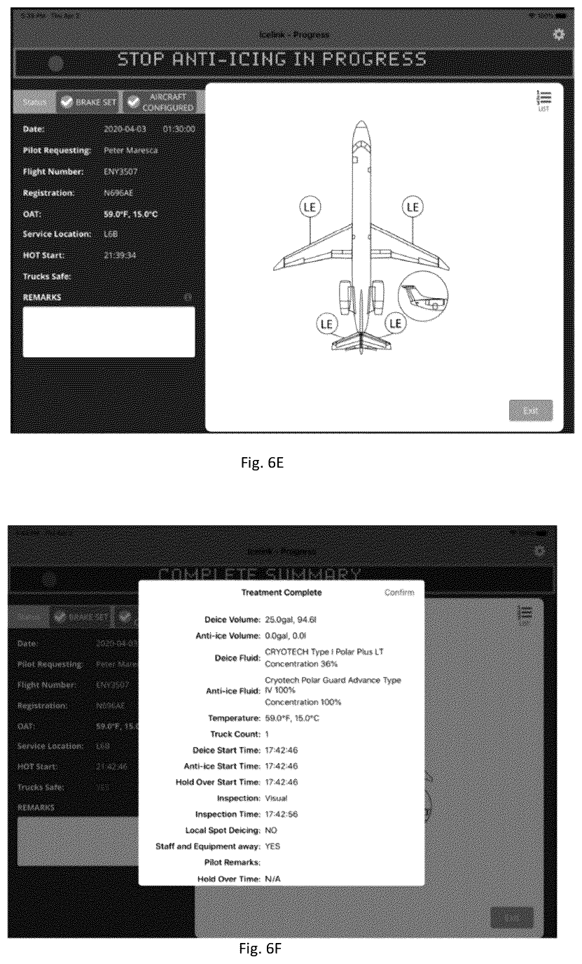

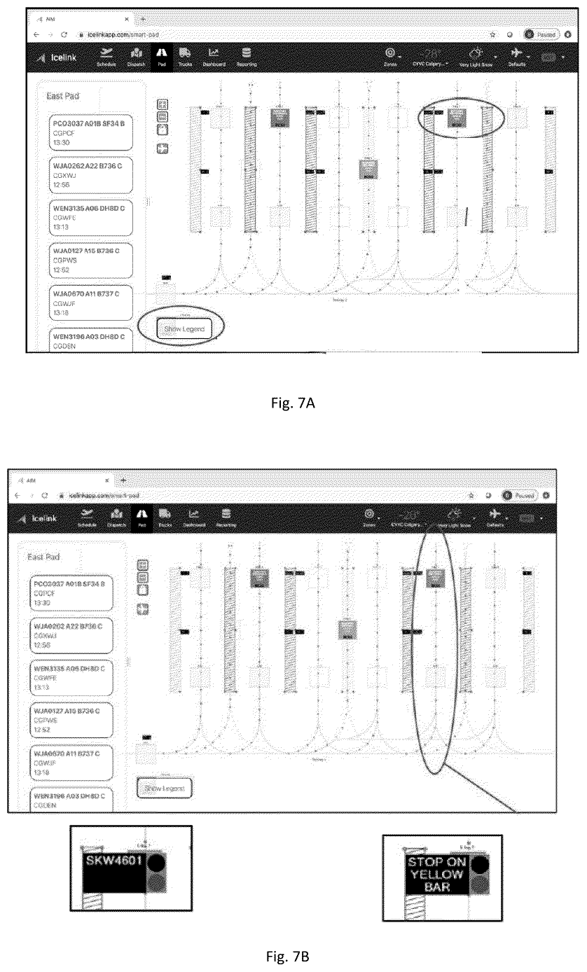

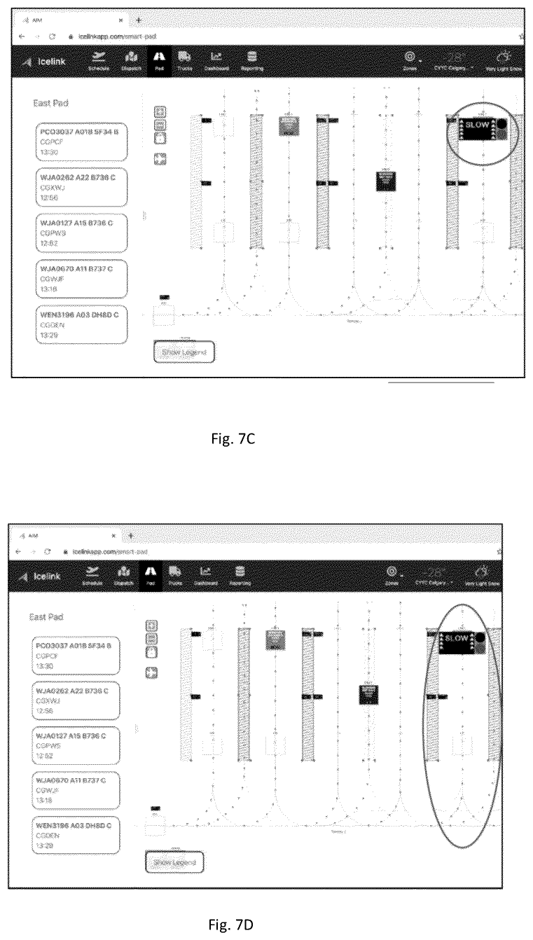

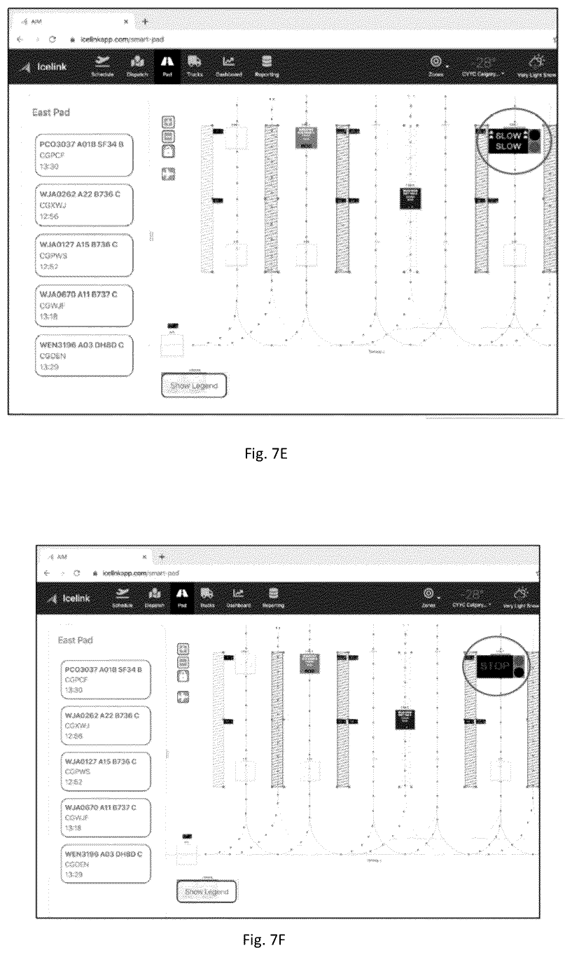

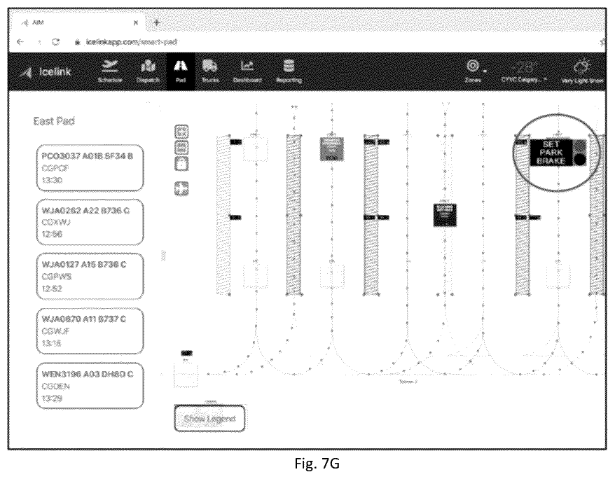

Turning to FIG. 5, a flowchart of another embodiment of controlling a contamination process for an aircraft is shown. FIGS. 6a to 6f and 7a to 7f provide example screenshots to support the flowchart of FIG. 5. In one embodiment, the method may be executed via instructions stored on a computer-readable medium such as by a processor or the CPU 102. The disclosure may also be seen as a system and method for the scheduling and guidance of an aircraft through a de-icing/anti-icing process.

Initially, an aircraft inbound queue is created or generated (500). The inbound queue includes or represents all of the aircraft that are waiting for de-icing/anti-icing in the airport and is typically created via a combination of inputs received from an Airport Collaborative Decision Making (ACDM) system, the pilot module or entered manually into the system. An example of manual input may include a de-icing coordinator (via the de-icing coordinator module) entering aircraft information relating to an aircraft that has requested de-icing or where an Air Traffic Control (ATC) or airport tower has requested a de-icing/anti-icing treatment to be applied to an aircraft.

Alternatively, when an aircraft is directed by ATC to push back from a gate, if de-icing/anti-icing is required, the pilot can request de-icing/anti-icing through the pilot application whereby the aircraft is then placed in the aircraft inbound queue based on information input by the pilot. Alternatively, the ATC may request an aircraft go through a de-icing/anti-icing process and then enters aircraft information into the system such that the aircraft is then placed into the inbound queue. Based on this information, the aircraft is entered into the aircraft inbound queue whereby the system then routes or guides the aircraft to a de-icing facility based the aircraft's characteristics, current location and outbound runway requirements, as will be described below.

Concurrently, while the inbound queue is being created, or updated, the system 102 provides the de-icing coordinator module with weather information such as, actual current weather from METAR, forecasted weather from a Terminal Area Forecast source and/or micro location weather from Nowcasting; aircraft situational awareness information from SWIM; electronic de-icing/anti-icing requests from pilots (via the pilot application); and/or situational awareness information about de-icing vehicles. Alternatively, or along with the above-identified information, the system (such as via the treatment plan engine) may then use the above information to generate an aircraft specific, cost effective, safe and time efficient de-icing treatment plan, or treatment plan template that is provided to the de-icing coordinator module. The coordinator can then adjust and/or approve the plan. Once the system 102 receives confirmation that the plan is approved by the de-icing coordinator, the plan is electronically transmitted to the pilot and displayed via the pilot application.

In another example, once the system receives a de-icing request from a pilot, the system receives or retrieves information associated with the aircraft for which the pilot made the request in order to input the aircraft information into the system (or treatment plan) so that the aircraft can be entered into the aircraft inbound queue. In a gate operation, where the engines are off and the aircraft is to be treated before leaving its parked position at the gate, a pilot may also make a de-icing request via the pilot module.

In another embodiment, the system receives or retrieves aircraft information, such as via a central repository, which allows the aircraft inbound queue to be created or modified. This may be performed automatically once a de-icing request is received by the system. Alternatively, aircraft information can be automatically entered into the aircraft inbound queue by retrieving information directly from the aircraft control system that requested the de-icing service.

Once in the queue, the system then determines where, a physical location within the airport, the aircraft should go (502) for de-icing/anti-icing or in what order and sequence an aircraft should be treated based on the availability of bays or de-icing machinery within the de-icing facility or facilities. The physical location may be a gate location (where the aircraft is currently parked), a location on the airport apron or tarmac, or a DDF.

A gate operation is when de-icing machinery, or vehicles, travel to the aircraft location to perform the de-icing/anti-icing procedure. In making this determination, different criteria may be used including, but not limited to, size of aircraft vs size of bay or bays and/or proximity of de-icing facility to departure runway. Other criteria may include, but not limited to, earliest scheduled departure, mainline or international flights priority, and giving higher priority by proximity of the nearest de-icing truck(s).

After making the determination, the system can then instruct the pilot where to go to receive the de-icing service or if the pilot is to stay in place as the de-icing may be performed as a gate operation. If the aircraft is required to travel to another location, in one embodiment, the system transmits a signal or message directly to the pilot via the pilot module. Alternatively, the system may transmit a signal or messages to at least one electronic message board (EMB) display. The signal may be a message representing instructions to the pilot regarding the location to go to in order to receive de-icing/anti-icing service or, as in the case of FIGS. 6a and 6b, information to the pilot where to move the aircraft too. These queuing signs may also display the type of de-icing/anti-icing treatment being or that will be applied and the current outside temperature. The system is preferably designed and tailored to assimilate to and graphically represent the airport including the airport's de-icing facility or facilities. Examples are schematically shown in FIGS. 6c and 6d which are screen shots of a gate operation de-icing view and a pad, or de-icing facility, de-icing view.

In one embodiment, if the information is transmitted to the pilot via one or more EMBs, the pilot may be notified of its location (or position) within the aircraft inbound queue and/or the radio frequency with which to contact a de-icing coordinator, if needed. Alternatively, communication between the pilot and the de-icing coordinator may be entirely handled by the system of the disclosure via the pilot module, the platform and the co-ordinator module.

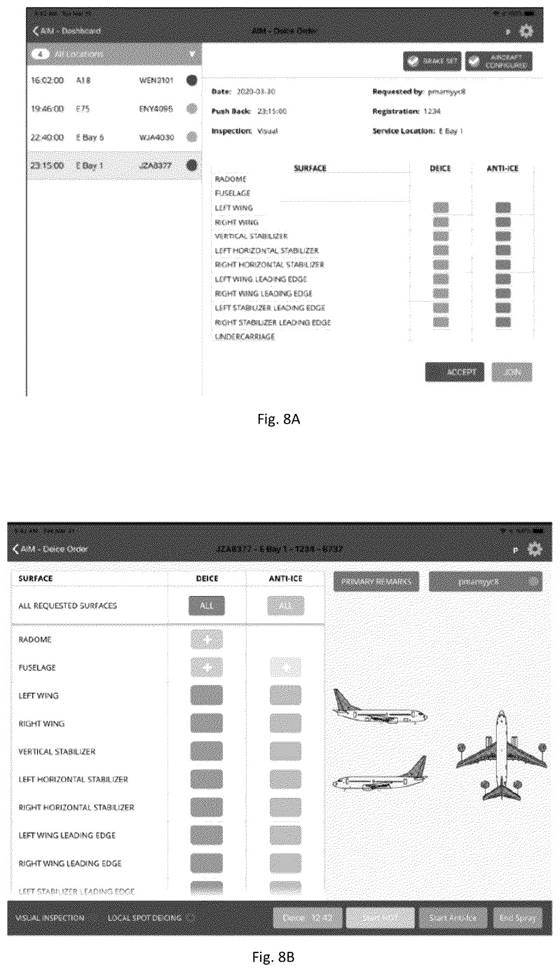

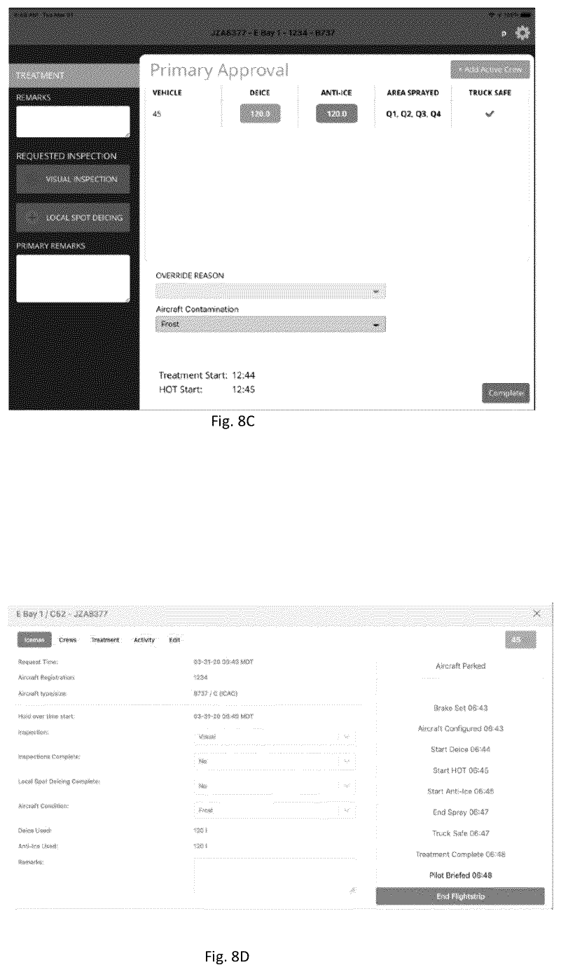

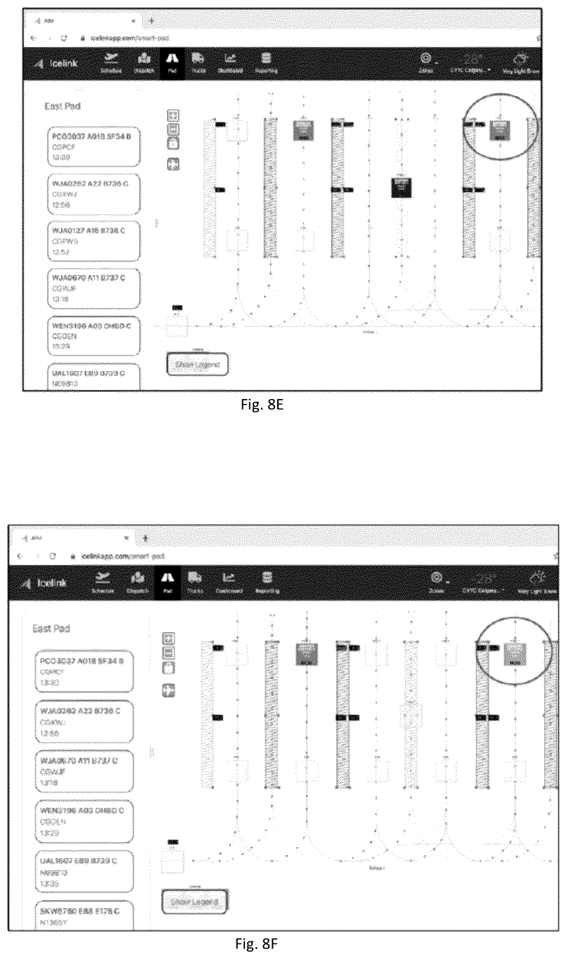

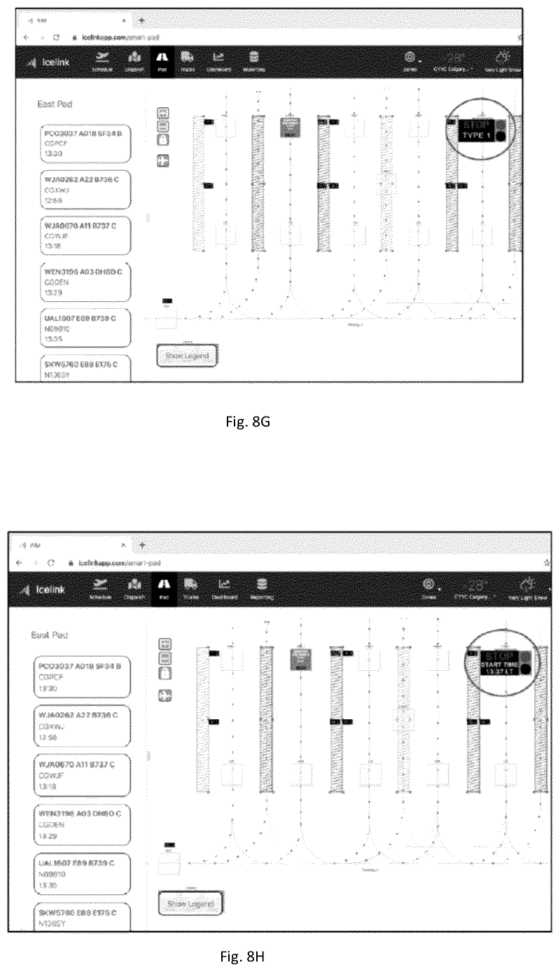

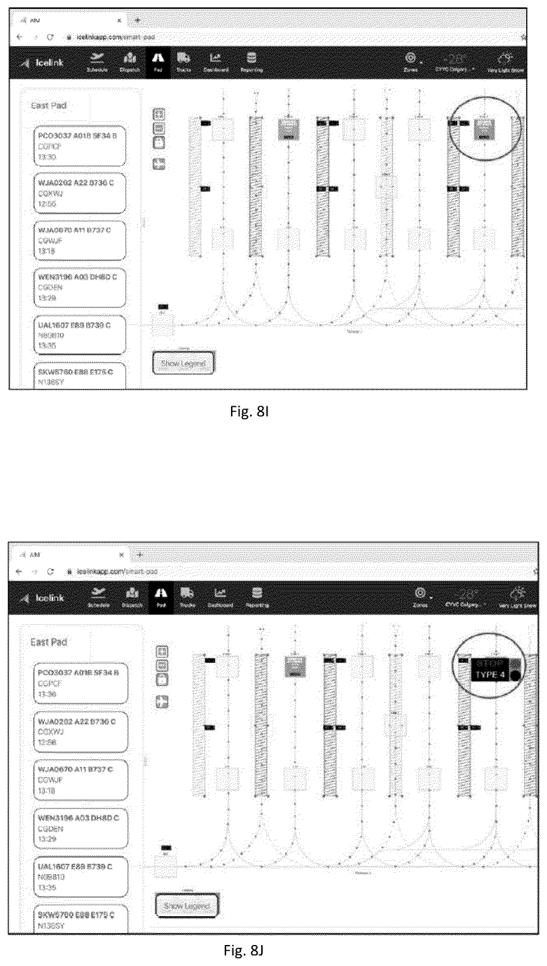

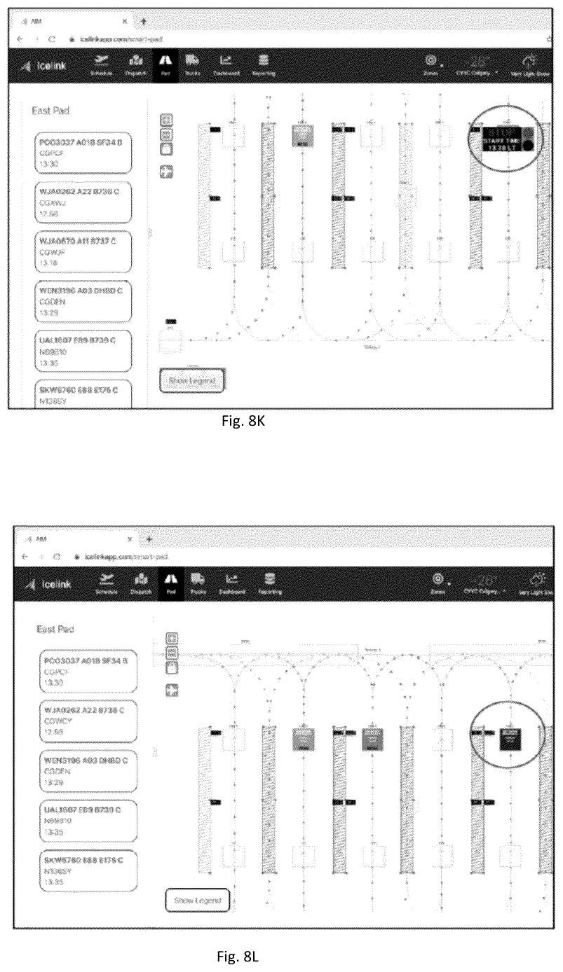

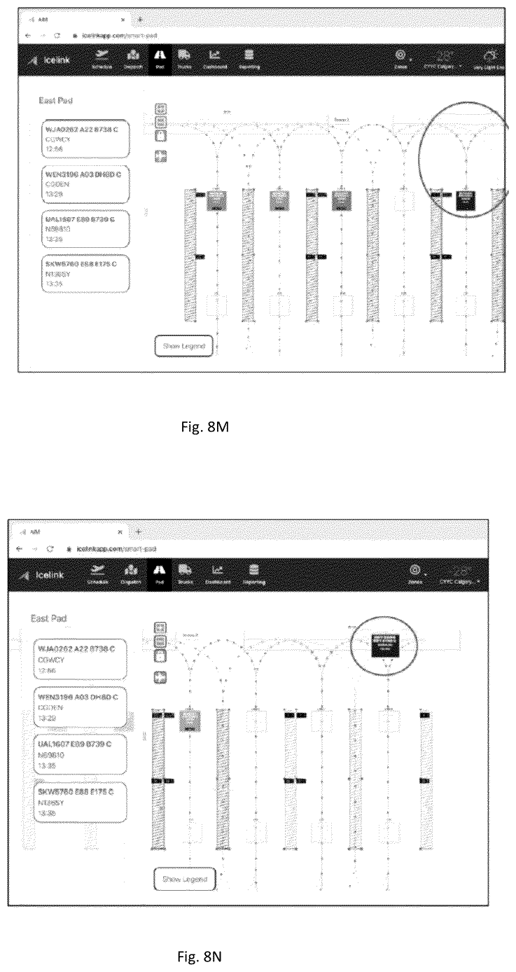

Through the messages, the pilot may be notified where to go for de-icing/anti-icing. In one embodiment, the system may also illuminate directional lights (506) such as in the taxiway to direct the pilot to the assigned de-icing bay to or within the de-icing pad or facility. The system may use positioning technologies to turn on and then off the correct lights. The state of the directional lights and the EMBs may also be displayed for a de-icing coordinator or operator of the system to review and control. Screen shots of what a de-icing coordinator may see are shown in FIGS. 7a to 7g. At this operational point, control of the process may be passed to the de-icing operators module or to a de-icing vehicle module. However, visibility of the process continues on the CPU 102 as can be seen in FIGS. 8e through 8n.

In one embodiment, the determination in (502) is performed to prepare the aircraft for de-icing/anti-icing. Alternatively, in another embodiment, the determination is performed when the aircraft is at the head of the aircraft inbound queue. In this embodiment, once the aircraft is at the front of the queue, the pilot is notified via the pilot module or EMB of the physical location where the treatment is taking place.

As will be understood, using positioning technologies and the EMB(s), the pilot may be provided instructions to slow and then stop the aircraft at a precise position that is designated for safe and efficient de-icing. Stop bars may be colored green, yellow and red to assist the pilot in positioning the aircraft in a safe zone. Brake zones or lines may also be employed whereby aircraft are required to park and then set their brakes to indicate that the aircraft is parked and not going to move.

In another embodiment, the system may also provide the ability for Smart Tower technology that allows de-icing personnel, or any other individuals, to view aircraft in the de-icing bay.

In one embodiment of the system, in order continually provide updates to the pilot, the system may recalculate and update HOT and other time estimates in real time with information from METAR, TAF, Nowcasting, SWIM and/or internal resource assignments. Time estimates may include a Pilot Timer for gate de-icing, a Line Up Time to Pad and/or a Time to Take Off. These may be presented as estimated delay minutes from normal. The Pilot Timer, Line Up Time to Pad are variants of Calculated Time to De-icing. In the case of gate de-icing, the Pilot Timer is the estimated time that the pilot can expect to have de-icing equipment reach the aircraft and begin de-icing. In the case of aircraft travelling to a physical location such as the DDF, the Line Up Time to Pad is the time the pilot can expect the aircraft to be accepted into the DDF to begin de-icing. These times are calculated based on at least one of historical information, changing weather, the de-icing equipment and operators available, transit times, aircraft delays, the number of aircraft scheduled for de-icing ahead of this aircraft, the length of time de-icing is currently taking and from available SWIM and ACDM information.

Calculated de-icing time is the estimated amount of time it will take to de-ice the aircraft once it is stopped and configured for de-icing. These times are calculated based on at least one of historical and time stamp information from de-icing truck operations such as spray times for de-icing fluid and anti-icing fluid. Time to Take-off is the estimated time that the aircraft will take-off. This is based on SWIM and ACDM information and the calculated de-icing time. The calculation also considers previous departure times for specific runways.

As operations proceed from marshalling the control of multiple aircraft into the DDF and subsequently into the correct bay, to the detailed workings of de-icing a single aircraft, the CPU passes control of the process to the de-Icer module that resides on multiple processors in the de-icing vehicles. Each de-icer operator module coordinates the operations of multiple de-icing vehicles as they work to de-ice a single aircraft. This module notifies the operators of the type of fluid to be used and aircraft surfaces to be de-iced. As de-icing proceeds, the system records the surfaces that have been treated and the amount and type of fluid used. Elapsed times of each step may also be recorded. This information is the communicated in real time to the CPU 102 and relayed to the pilot via the pilot module). In addition, this information is stored in a database for future reporting and analysis. Video may also be provided by the de-icing vehicles for viewing on the pilot module.

In another embodiment, the visual systems (EMBs and taxiway lighting) provide real-time safety measures by confirming that aircraft to de-icer incursion zones are observed and met. If not, alarms may be sounded to notify the de-icing operator, the de-icing vehicle, and the central operations facility.

When de-icing operations are complete, the de-icer operator module provides a signal to the CPU 102 or coordinator module indicating completion. This may be via an input to the de-icing operator module from the de-icing vehicle or the de-icing operator which is then transmitted to the coordinator module. Alternatively, either manually or through geo-positioning, once the system is notified that the vehicle has reached a safe parking destination, the CPU 102 may then take over control of the movement of the aircraft from the physical location to its runway so that the aircraft is safely marshalled out of the facility.

In one embodiment, during the final phases of the de-icing/anti-icing process, the modules work hand in hand to ensure all electronic communication via the pilot module, the at least one de-icing vehicle module, and the coordinator module ensure each stakeholder is on the same page during each phase of the electronic communication process. This allows for safe handoff to EMB messages for the pilots EMB exit instructions. These EMB messages are visually available to the coordinator for monitoring.

In another embodiment, the de-icer operator module may be installed onto an autonomous (un-manned) de-icing vehicle. Aircraft specifications, incursion zones, movement patterns, de-icing surface requirements, fluid requirements, post de-icing inspection requirements and specification concerning nearby vehicles will be downloaded to the de-icer operator module that will control the autonomous de-icing vehicle.

When de-icing/anti-icing is completed, and de-icing equipment and personnel are in safe positions, the system may then notify the pilot to proceed. Once the pilot has been notified, the system may transmit signals to illuminate TIGLs to assist the pilot to leave the de-icing bay. In one embodiment, the system may use positioning technologies to turn on and then off the correct lights. The green lights indicate to the pilot to proceed forward while the red lights indicate to other aircraft not to proceed forward into the bay. Other aircraft information may be displayed to the operator such as the brake status of the aircraft.

Information associated with every part of the process may be stored in a database for future retrieval and reference. Analysis of this data is used to improve de-icing operational performance, reduce de-icing fluid usage, reduce aircraft engines on time and/or increase operational safety.

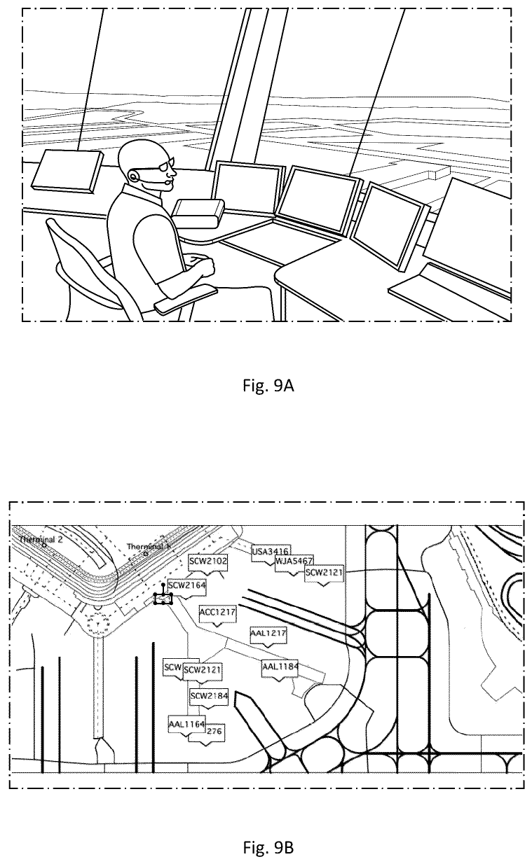

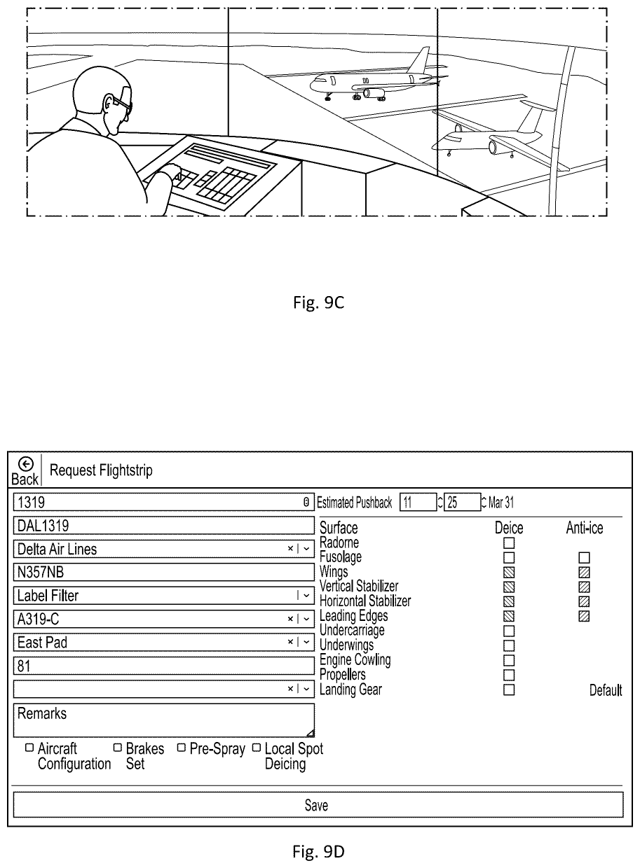

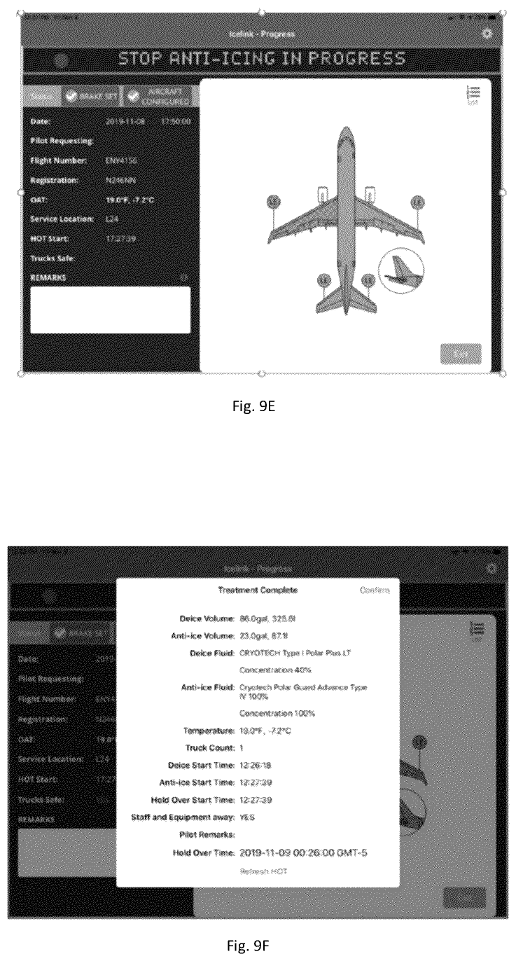

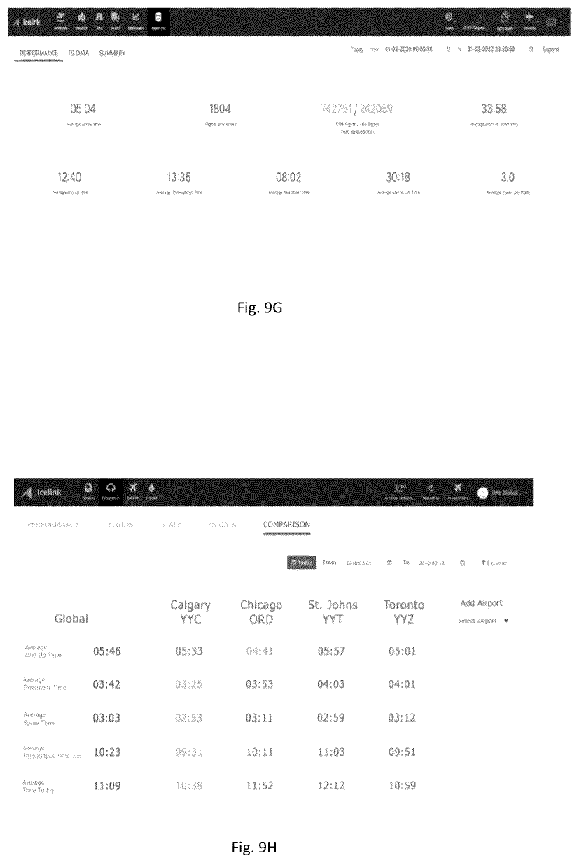

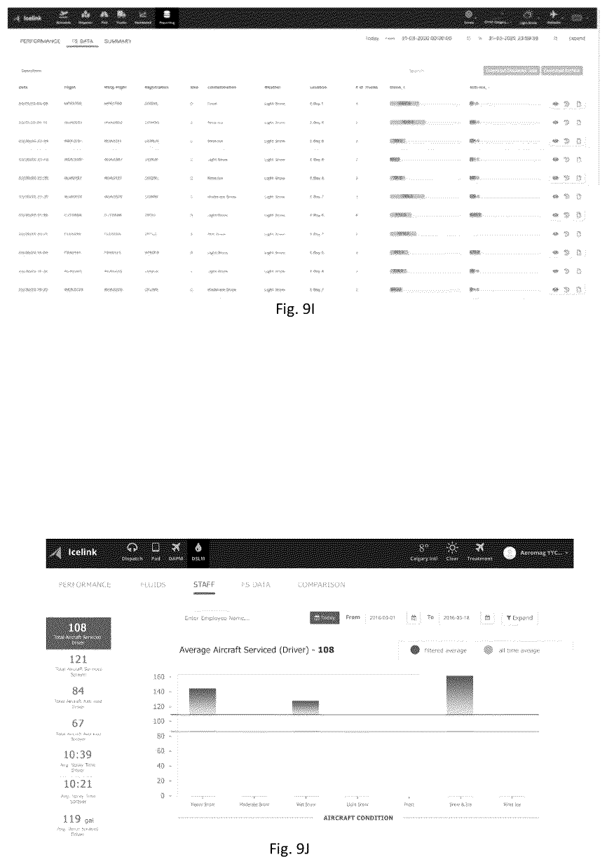

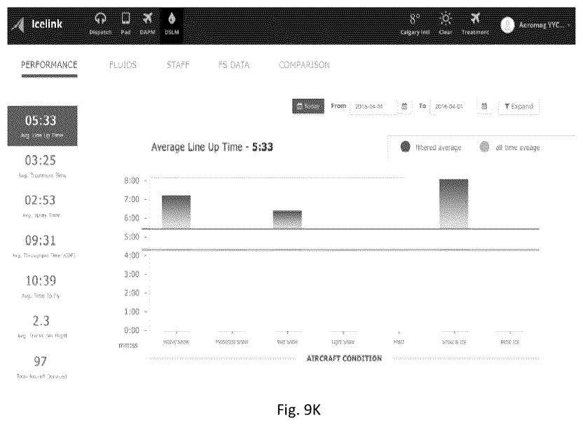

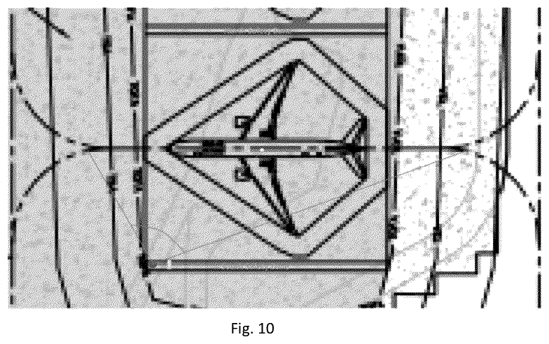

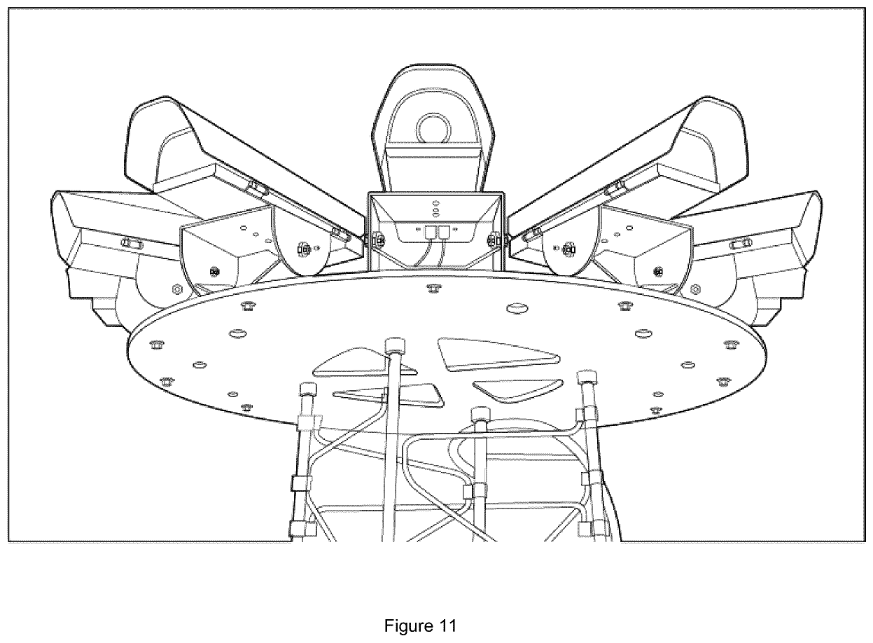

As shown in FIG. 9a, a de-icing coordinator within the ATC tower may be able to review various screen shots (which in this figure relates to a gate de-icing operation) providing an overview of the airport and where aircraft and de-icing bays may be located. An indication where EMBs are located may also be displayed. An example screen shot of what the de-icing coordinator is looking at is shown in FIG. 9b. As such, the de-icing coordinator may independently manage the de-icing/anti-icing process, such as a gate operation or a pad, or DDF, operation and/or any machinery respectively directly via the de-icing coordinator module installed on a tablet or computer system or the system may be able to do it autonomously. The de-icing coordinator, via the co-ordinator module may remotely manage and command and control all de-icing/anti-icing operations of any size scale and scope, either engines on or gate, stand, area, DDF etc . . . All Management, direction, commands, situational awareness, status of aircraft and de-icing fleet, Airline Flight Schedule, weather systems (such as hold over times), flight strips, other software modules related to de-icing can be housed, interpreted and received and/or pushed out to the operation/airport in real time remotely from any location. Multiple operations can be run from one central point location. FIG. 9c provides a photograph of a de-icing coordinator viewing a display showing a pad-de-icing operation with FIG. 9d being a schematic screen shot the de-icing coordinator may be looking at.

Further schematic screenshots are shown in FIGS. 9e to 9k. FIG. 9e is a de-icing fluid flow screenshot, FIG. 9f is a de-icing performance dashboard screenshot, FIG. 9g is an average treatment times and fluid usage screenshot, FIG. 9h is a measurements comparatives against other airports screenshot (Global Performance Reporting), FIG. 9i is a trending and overall conditions screenshot, FIG. 9j is a trending KPI's Staff screenshot; and FIG. 9k is a trending KPI's overall performance screenshot. Each of the screenshots may provide further information regarding the de-icing/anti-icing equipment to the de-icing operator.

Advantages of the some embodiments of the disclosure include, but are not limited to, increased aircraft throughput in the DDF, reduced chemical usage; and increased safety to aircraft and to de-icing operations personnel; a measurable and manageable de-icing/anti-icing process; and metering aircraft throughout the de-icing/anti-icing processes to determine overall de-icing/anti-icing processes times to assess overall airport performance.

In another embodiment, the system may provide, such as via a screen or display, as schematically shown in FIG. 10, safety zones around the aircraft. In the current figure, two safety zones are indicated with the center of the de-icing bay is indicated by the circle. In the current example, one EMB is in a corner of one of the safety zones. In a preferred embodiment, angling of the face of the EMB is about perpendicular to the center of the bay for ease of review by the pilot. For this embodiment, this location was chosen so that the pilot can see the EMB (120 degree visibility) as the pilot enters the bay to the stop bar as the EMB is preferred to be at right angles to the centerline close to the bow of the aircraft; the position provides a larger or maximum area for de-icing rigs to park in the safety zone; and the position provides good field of view for cameras used for aircraft position detection and distance detection. This is disclosed in more detail below.

In one embodiment, the camera(s) can be mounted on EMBs or on separate dedicate masts. In a preferred embodiment, camera heights can range from approximately 2m to approximately 7m. Each camera preferably has a field of view (FOV) of about 70 degrees to detect the nose of the aircraft as they enter, transit and exit the bay. The camera FOV is indicated by the green lines. In one embodiment, there are to be no objects within the FOV during detection operations, however, if there are vehicle operators that are not aware of this, they may drive and/or park in front of EMBs. In these embodiments, the system may include apparatus for detecting aircraft behind these vehicles and other obstructions, such as, but not limited to precipitation or wiper blades which are used to remove precipitation. The system of the disclosure may also implement filters and a projection tracking module and/or algorithm to predict where a previously unobscured aircraft is likely to be while it is obscured.

The yellow bar in the safety zone is one possible limit of where a de-icing vehicle and its boom can be parked such that it will not be damaged by the aircraft or cause damage to the aircraft.

In another embodiment, the system may perform one or more functions (or methods) including, but not limited to: structuring the flow of aircraft into and out of a DDF; providing the ability for an individual to view the entire de-icing/anti-icing operation; providing multiple operators graphical representation of all de-icing/anti-icing equipment and their inventory status/location and personnel aboard with time stamps at task completion intervals and activates/deactivates/displays/status all necessary guidance equipment; using TIGL equipment to illuminate and illustrate the path for a specific aircraft which is addressed by an operator; using EMBs to display messages with standardized directions for aircraft movement into, around and out of a de-icing facility and a bay within the de-icing facility; using specialized technologies (such as, but not limited to, camera equipment and satellite based aircraft tracking software to track, guide, position and stop aircraft movement in and around the de-icing facility); using specialized lighting technologies and techniques to direct aircraft into, out off and around the de-icing facility that is preferably dedicated to specific aircraft movement and treatment in operational requirements and conditions; automating aircraft movement; using EMBs to display standardized messages concerning the de-icing activities occurring to and around the aircraft; storing in a database important information for improving aircraft de-icing efficiency; long term safety auditing; de-icing chemical application, storage and reclamation; KPI and benchmarking; real-time analytics in a live operation (to adjust operation on the fly) and actionable analytics and visibility on achievable schedule commitments; using a camera system to detect the presence of contamination on aircraft surfaces for use in treatment recommendations; continuous monitoring of operations as fluid is applied via an automated or manual process; post de-icing/anti-icing inspection of aircraft surfaces for remaining contamination or contamination not visible to the human eye; exception monitoring for accidental aircraft contacts; detecting improper procedure such as fluid sprayed into an engine inlet, APU, or other sensitive area of the aircraft which should not have fluid applied; safety monitoring for ground equipment or personnel improperly placed outside of safety zones during safety critical periods of the operation; external, unbiased and automated confirmation of spray start & end times, ensuring what is being recorded by an operator through other parts of the system is physically happening.

In a further embodiment, the system may include aircraft position detection equipment. Aircraft position on the taxiways, de-icing pad and bays can be transmitted to the system from aircraft satellite tracking systems in order to provide positioning data for the system. In addition, the architecture of the system of the disclosure may receive aircraft position from external systems.

In one embodiment, the aircraft position detection equipment includes a Smart Tower. In this embodiment, the system allows individuals to view de-icing facilities from a remote or off-site location. In conjunction with the system of the disclosure, the DDF can be viewed and controlled from the remote or off-site location.

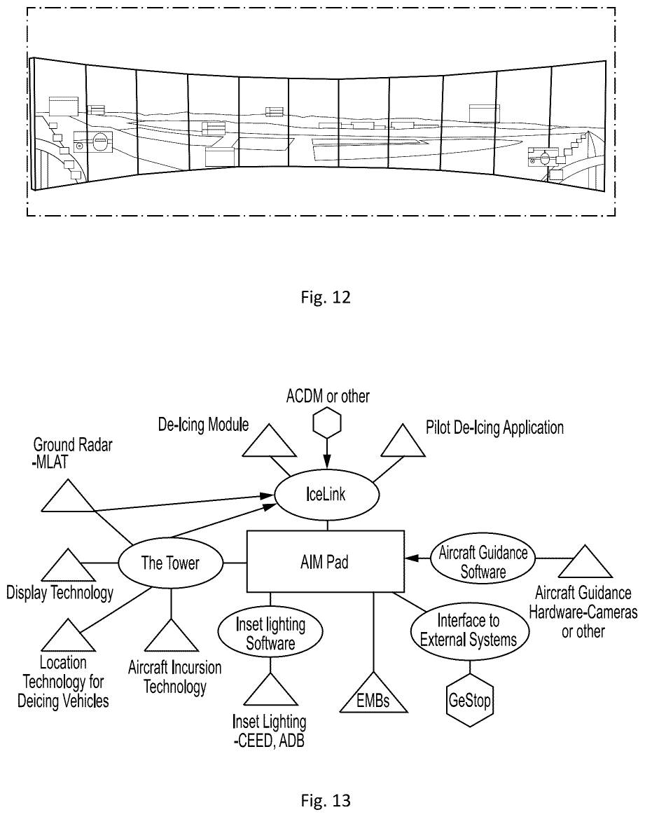

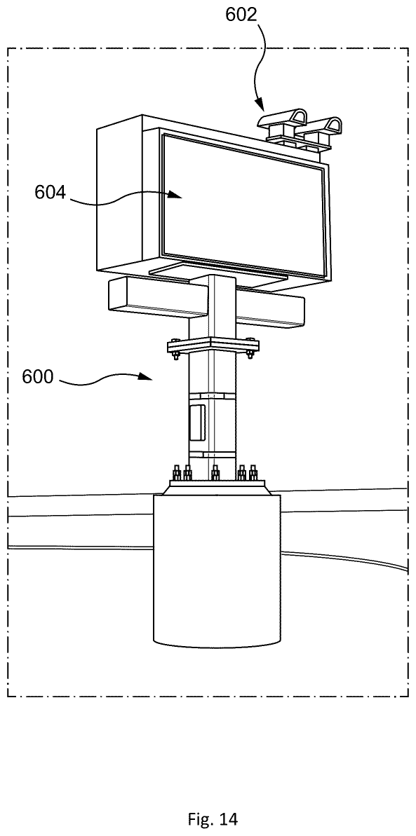

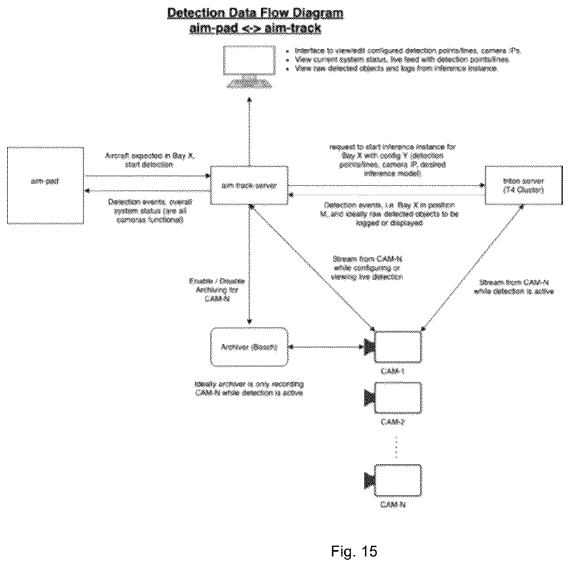

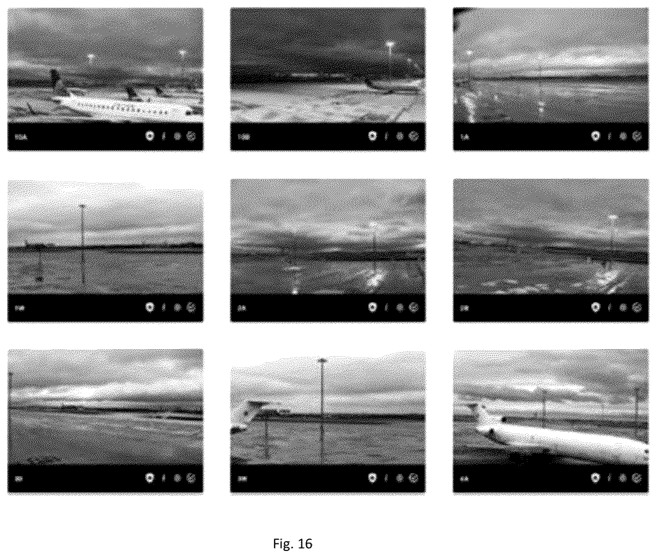

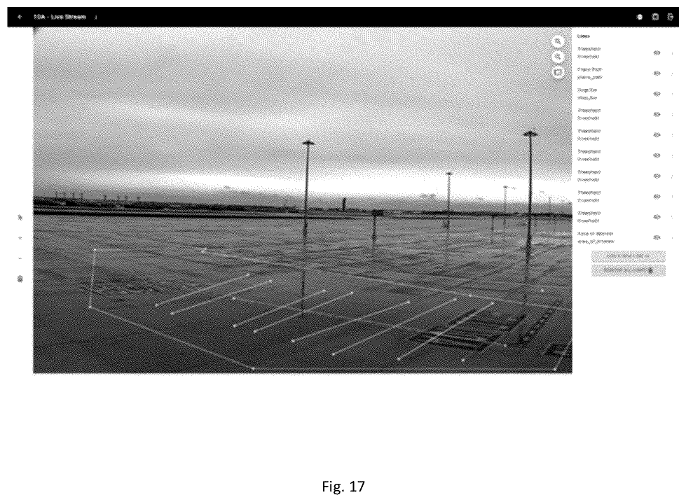

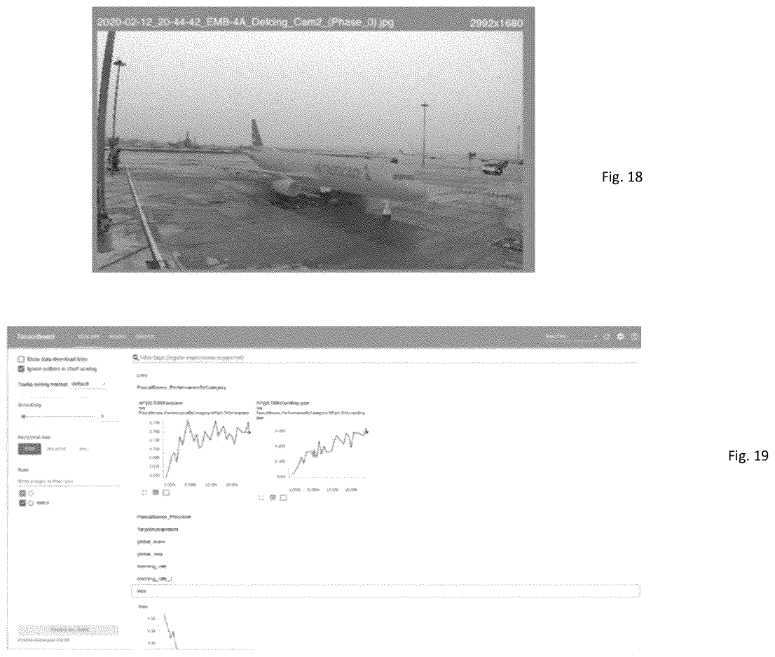

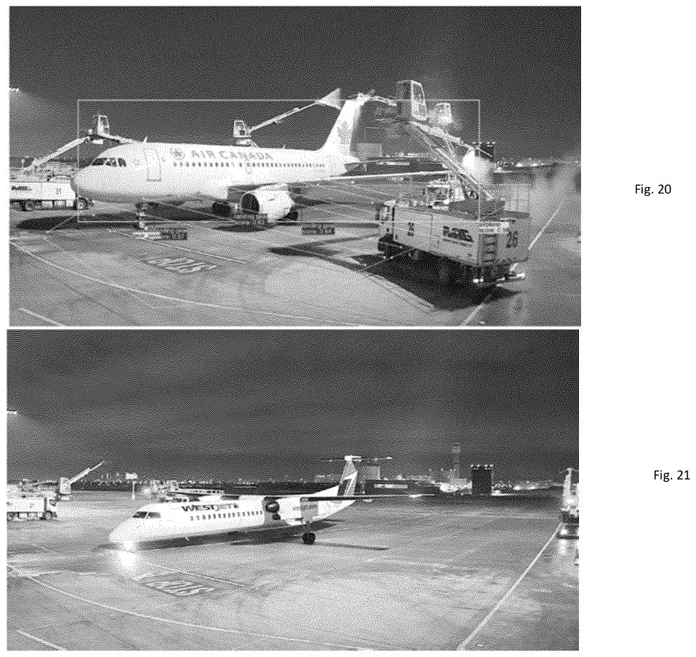

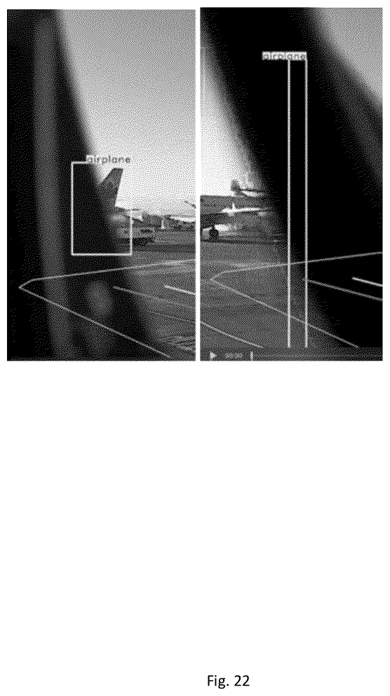

As schematically shown in FIG. 12, information or data from the cameras may be stitched together to create a panoramic view of the facility. In another embodiment, the stitching of camera feeds may be from multiple EMBs thereby providing an operator or user of the system with a multi-perspective view or their operation on a bay-by-bay basis.

In one embodiment, information from the Smart Tower may be processed by the system to include geo-tagging and/or information tagging of aircraft and de-icing vehicles. De-icing vehicles may be seen as vehicles that may travel to positions where aircraft are located in order to perform de-icing or vehicles that move around a de-icing facility in order to de-ice an aircraft. The processing of the tower information to include geo-tagging and/or other tagging information is an improvement over current human visual system. The system may also use this geo-tagging information to provide safety measures during the de-icing process. For instance, by using the geo-tagging information, aircraft incursions zones may be generated so that if the aircraft enters an incursion zone, messages are transmitted to the aircraft to stop or to warn the aircraft of possible danger.

A further advantage of the current system is that the system allows processing of aircraft and de-icing vehicles such that all aircraft and de-icing equipment or vehicles are tagged with identifiers. In a preferred embodiment, the de-icing equipment may provide additional information such as, but not limited to, displaying fluid levels and other de-icing information. Another advantage of the system of the disclosure is the provision of aircraft incursion safety zones that are displayed around aircraft, indicating (alarming, annunciating) zones where vehicles or static equipment may contact aircraft surfaces. Another advantage of the system is that if an aircraft is sensed to have entered an incursion zone, the system may generate warning messages on the EMBs and/or not allow an operator of the system to let the aircraft make any further movements. In one embodiment, as the system is already aware of the aircraft size from previously inputted information, the system may direct the aircraft into a de-icing bay that is suitable for its size. However, it is possible that the inputted information may be mislabelled or entered incorrectly whereby the expected vs actual aircraft size may differ. The system can then update its information and instructions accordingly. Also, the system may verify the registration number and aircraft make/model upon its arrival to the de-icing bay or pay for an additional safety/accuracy check.

The system may also include video tagging identifying de-icing vehicles and aircraft on the ground; a view of de-icing vehicle informatics such as alarms and fluid levels; an overlay of aircraft incursion zones on the operator display; safety systems that notify operators, such as those controlling a de-icing vehicle remotely, that their de-icing vehicles are near aircraft; and/or safety systems that reduce the risk of aircraft movement when incursions are detected.

A schematic diagram of another embodiment of a system for controlling a de-icing/anti-icing procedure is shown in FIG. 13.

The system may further include safety zone lighting. As each de-icing bay has zones dedicated to safe parking of large de-icing trucks. These safe zones reduce the likelihood that that aircraft and de-icing trucks damage each other. The trucks take up these positions when aircraft are in motion or are about to move. This may also be seen as position optimization.

Safe, or safety, zones are preferably designated by specific lights and paint schemes. The system may provide mechanisms to turn on and off the bays safe zone light, to announce to the de-icing operators or de-icing vehicles that aircraft are moving or are about to move and where to park the de-icing trucks or vehicles.

The capability of clearly designating safe zones is especially important when a de-icing facility has composite bays. Composite bays are used to de-ice a single large aircraft or simultaneous de-icing of smaller aircraft.

Utilizing the aircraft class (size), and the configuration of the composite bay, the system may automatically configure the lead in and out taxiway lights and/or safety zone lighting.

In one embodiment, the lighting around the perimeter of the safe zones clearly identify the location of the safe zones in all weather. In another embodiment, the safe zone lighting is part of the configurator of various requirements of a DDF.

In one embodiment, the configurable lighting orientations allow the de-icing pad to be orientated as per their requirements controlled by specific and graphically representative icons and displays of active and inactive equipment (lighting, trucks, and aircraft on the client interface). Also, the dedicated control of each lighting strand (per de-icing bay within the pad) allows for the operator to have positive control of the aircraft. Also, the system may include a way to automatically trigger functions through either multilateration equipment that is either ground based or satellite based which identifies the proximity of the aircraft position and commands the aircraft through lighting and or Signboards (EMBs) to safe position in the ingress and egress of the de-icing process in a DDF or a stand, area, bay etc . . . In a further embodiment, the system includes Management User Services to generate and automate performance reports with real time information and management of any operation which provides the platform of the ability to remotely manage it.

In one embodiment, the system may enable a de-icing coordinator (or the de-icing coordinator module) to marshal aircraft to the physical location (such as the DDF) with pilot instructions displayed on EMBs whereby once in the DDF, control is passed to the de-icing operator's application.

In some embodiments, the CPU may updated estimated wait times, time to de-ice and time to take off based on delays from normal operations and information supplied by the external sources. In some embodiments, as the treatment proceeds, the pilot application or module may display updates with respect to the surfaces that are being, or have been treated, fluid types and amounts.

In another embodiment, when an aircraft is accepted into the de-icing facility, the pilot is notified, such as via the pilot module or via radio, which de-icing bay to travel too. The system tracks the aircraft into the bay and displays when the aircraft should stop such as by providing visual indicators to the pilot. The system may then notify the de-icing operators (or vehicles), manually operated or automated, that it safe to begin de-icing. The de-icing module displays or controls where the de-icing vehicles should be placed and the surfaces that are to be treated. Using sensors installed in the de-icing vehicles, this module tracks the surfaces being treated, the fluid amounts and types being applied and the time duration. The de-icing operators module also provides notifications, or treatment updates, to the pilots through the EMBs or the pilot module. This information is reported and stored in the CPU 102.

Where necessary, the CPU 102 may communicate with a global Air Traffic Management Initiative (SWIM) to retrieve or share situational awareness information. The CPU may also access an airport collaborative decision-making systems (ACDM) which provides supplies scheduling information to the CPU 102 or system 100. Some further components that may be in some embodiments of the disclosure may include, but is not limited to, Ground Radar (MLAT) which provides aircraft positions on the airfield; the Tower component which may be seen as software, camera technologies, GPS technologies and display technologies; Taxiway Ground Inset Lights which may be seen as a combination of software and Taxiway Inset Light systems that are controlled by the system; EMBs that display information to pilots; Aircraft Guidance Software & Hardware (cameras and infrastructure) that detects the distance an aircraft is from preferred stopping points; interfaces to external systems functionality to communicate with other systems or databases; and management user services which provides the functionality of a reporting platform that provides historical and real-time reports of airport Key Performance Indicators, Global Performance Overviews of multiple and global de-icing facilities.

One advantage of the system is imprecise and often misinterpreted VHF radio communication is reduced or eliminated. Another advantage of the system and method of the disclosure is the provision of a highly efficient and co-ordinated management and operational platforms of automation and/or remote command and control of de-icing services for aircraft.

In another embodiment, the disclosure includes the co-ordination of messages via the EMBs to assist the pilot in navigating the tarmac. In another embodiment, the disclosure also includes the controlling of taxiway inset guidance lights (TIGL), to assist the pilot in navigating the tarmac by providing these lights to guide the aircraft from location to location such as from the gate to the de-icing facility to the runway. In one embodiment, all active components of the guidance equipment are displayed on a user interface in real-time to provide a pilot a graphical simulated live view of the conditions of their de-icing operation.

In one embodiment, the disclosure can be seen as a system that includes at least one software module that provides a terminal gate graphical representation and active client interface, a set of electronic message boards, taxiway lighting and positioning technologies for the aviation de-icing industry that facilitates the precise and efficient real-time coordination de-icing of aircraft.

In another embodiment, the disclosure is directed a computer readable medium having instructions stored thereon that, if executed, causes multiple distributed processors to control EMBs, TIGLs and positioning/metering and docking technologies as well as visual surveillance technologies for the aviation de-icing industry that facilitates the automated and remote management operations of aircraft at a DDF (central De-Icing Facility) and/or gate operations for the de-icing of aircraft.

In one aspect, there is provided a method of facilitating de-icing for an aircraft including placing the aircraft in an inbound queue; determining a location for de-icing of the aircraft; and guiding the aircraft to the location.

As discussed above, the system of the disclosure may be implemented using a combination of software, hardware and/or firmware. In one embodiment, the system includes a computer readable medium that includes computer-executable code that, when executed, provide a method of controlling of configuring a de-icing/anti-icing process for an aircraft.

In the preceding description, for purposes of explanation, numerous details are set forth in order to provide a thorough understanding of the embodiments. However, it will be apparent to one skilled in the art that other arrangements and embodiments would be feasible.

The above-described embodiments are intended to be examples only. Alterations, modifications and variations can be affected to the embodiments by those of skill in the art without departing from the scope of the application, which is defined solely by the claims appended hereto.

What is claimed is:

1. A method of automating aircraft de-icing/anti-icing comprising:
generating a treatment plan for aircraft de-icing/anti-icing;
communicating the treatment plan to a pilot module associated with the aircraft for input relating to the treatment plan from a pilot associated with the aircraft;
updating the treatment plan based on the input from the pilot; and
transmitting the updated treatment plan to at least one de-icing/anti-icing vehicle for performance of the updated treatment plan;
wherein generating the treatment plan for aircraft de-icing/anti-icing includes receiving or retrieving weather information.

2. The method of claim 1 further comprising:
receiving a request for aircraft de-icing/anti-icing before generating the treatment plan for aircraft de-icing/anti-icing.

3. The method of claim 1 further comprising:
receiving a request for aircraft de-icing/anti-icing after generating the treatment plan for aircraft de-icing/anti-icing.

4. The method of claim 1 wherein generating the treatment plan comprises:
receiving weather information from METAR or Nowcasting.

5. The method of claim 1 wherein updating the treatment plan comprises:
determining a physical location for performing the aircraft de-icing/anti-icing where the physical location is a gate location, an apron location or a designated de-icing facility (DDF).

6. The method of claim 5 wherein if the physical location is a gate location, transmitting the updated treatment plan to at least one de-icing/anti-icing vehicle for performance of the updated treatment plan includes transmitting the gate location to the at least one de-icing/anti-icing vehicle.

7. The method of claim 5 wherein if the physical location is a DDF, the method further comprising:
guiding the aircraft from its current location to the DDF.

8. The method of claim 7 wherein guiding the aircraft from its current location to the DDF comprises:
controlling taxiway inset guidance lights.

9. The method of claim 7 wherein guiding the aircraft from its current location to the DDF comprises:
transmitting messages to the pilot via electronic message boards (EMBs).

10. The method of claim 1 further comprising, after the aircraft de-icing process has commenced:
receiving de-icing/anti-icing process updates from the at least one de-icing/anti-icing vehicle; and
transmitting the de-icing/anti-icing process updates to the pilot application.

11. The method of claim 10 wherein receiving de-icing process updates comprises:
receiving real-time video from the at least one de-icing/anti-icing vehicle.

12. The method of claim 11 wherein transmitting the de-icing/anti-icing process updates comprises:
transmitting the real-time video to the pilot application.

13. The method of claim 10 further comprising:
transmitting the de-icing/anti-icing process updates to electronic message boards.

14. The method of claim 1 further comprising:
determining when an aircraft has set its brakes;
transmitting a message to the at least de-icing/anti-icing vehicle that it is safe to proceed.

15. The method of claim 14 further comprising:
receiving confirmation from the at least one de-icing/anti-icing vehicle that the de-icing/anti-icing treatment is complete and that the at least one de-icing/anti-icing vehicle is in a safe zone; and
transmitting a signal to the pilot via the pilot module that the aircraft may proceed to take-off.

16. The method of claim 14 further comprising:
transmitting control of the system to the de-icing module after transmitting the message to the at least de-icing/anti-icing vehicle that it is safe to proceed.

17. The method of claim 15 further comprising:
receiving control of the system after receiving confirmation from the at least one de-icing/anti-icing vehicle that the de-icing/anti-icing treatment is complete and that the at least one de-icing/anti-icing vehicle is in a safe zone.

18. A non-transitory computer readable medium having stored thereon software instructions that, when executed by a processor, cause the processor to:
generate a treatment plan for aircraft de-icing/anti-icing;
communicate the treatment plan to a pilot module associated with the aircraft for input relating to the treatment plan from a pilot associated with the aircraft;
update the treatment plan based on the input from the pilot; and
transmit the updated treatment plan to at least one de-icing/anti-icing vehicle for performance of the updated treatment plan;
wherein generating the treatment plan for aircraft de-icing/anti-icing includes receiving or retrieving weather information.
